(19) United States
(12) Patent Application Publication
(10) Pub. No.: US 2025/0232366 A1
(43) Pub. Date: Jul. 17, 2025

(54) REGISTERING NEW CONTACTLESS CARDS TO EXISTING ACCOUNT

(71) Applicant: Capital One Services, LLC, McLean, VA (US)

(72) Inventors: Jeffrey Rule, Chevy Chase, MD (US); Lawrence Douglas, McLean, VA (US); Jackson Macomber, Henrico, VA (US)

(73) Assignee: Capital One Services, LLC, McLean, VA (US)

(21) Appl. No.: 18/413,696

(22) Filed: Jan. 16, 2024

(51) Int. Cl. G06Q 40/02; G06Q 20/34; H04L 9/40

(52) U.S. Cl. CPC G06Q 40/02; G06Q 20/352; H04L 63/0853

(57) ABSTRACT

Methods, techniques, and embodiments are generally directed to systems for receiving a request from an authenticated computing application to associate a contactless card with an account. The systems then authenticate that the request came from an account holder. After establishing the authenticity of the account holder, the systems determine a unique identifier for the account holder associated with the account. Finally, the systems send a second request to the authenticated computing application to write this unique identifier onto the contactless card.

### BACKGROUND

The present application relates to computing technology and facilitates dynamically programming a contactless card to register it to an existing account in a secure manner.

In order to replace a contactless card, a cardholder requests a new card through an account provider (e.g., a bank, financial institution, retail store, and other card providers). This process may require a cardholder to physically visit a location associated with the account provider to receive a new card or request a new card to be delivered to the cardholder's address. A cardholder may be unable to visit the location associated with the account provider (e.g., if the cardholder is out of the country or not near any account provider locations if the cardholder is unable to visit during business hours, etc.). Additionally, a cardholder may not be able to wait a number of days until a new card is delivered. Accordingly, there is a need to provide a new contactless card faster and in an authenticated and secure manner to facilitate the cardholder to be able to access the account without delay.

### SUMMARY

In one aspect, a computer-implemented method to program a contactless card comprises receiving, by a server, a first request to associate the contactless card with an account, the first request received via an authenticated computing application. The computer-implemented method to program a contactless card further comprises authenticating, by the server, that the first request was received from an account holder of the account; and based on establishing authenticity of the account holder, determining, by the server, a unique identifier of the account holder associated with the account, and sending, by the server, a second request to the authenticated computing application to write the unique identifier of the account holder to the contactless card.

In another aspect, a computing device comprises: a processor; and a memory storing instructions that, when executed by the processor, configure the computing device to receive a first request to associate a contactless card with an account, the first request received from a second computing device; authenticate that the first request was received from an account holder of the account; and based on establishing authenticity of the account holder, send a second request to the second computing device to write a unique identifier of the account holder to the contactless card.

In a further aspect, a non-transitory computer-readable storage medium includes instructions. When executed by a computing device, the instructions cause the computing device to receive a first request to associate a contactless card with an account, the first request received from a second computing device; authenticate that the first request was received from an account holder of the account; and based on establishing authenticity of the account holder, send a second request to the second computing device to write a unique identifier of the account holder to the contactless card.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates method 300 in accordance with one embodiment.

FIG. 4 illustrates an aspect of the subject matter in accordance with one embodiment.

FIG. 5 illustrates an aspect of the subject matter in accordance with one embodiment.

FIG. 6 illustrates an aspect of the subject matter in accordance with one embodiment.

FIG. 7A illustrates a contactless card in accordance with one embodiment.

FIG. 7B illustrates a contactless card 102 in accordance with one embodiment.

FIG. 8 illustrates a data structure 800 in accordance with one embodiment.

FIG. 9 illustrates a computer architecture 900 in accordance with one embodiment.

FIG. 10 illustrates a sequence flow 1000 in accordance with one embodiment.

FIG. 11 is a diagram of a key system according to an example embodiment.

FIG. 12 is a flowchart of a method of generating a cryptogram according to an example embodiment.

FIG. 13 illustrates an aspect of the subject matter in accordance with one embodiment.

### DETAILED DESCRIPTION

Embodiments disclosed herein provide techniques for registering a new contactless card to an existing account of an account holder (i.e., a user). The contactless card can be an electronic device, such as an identification key, a phone, or any other electronic device that can be used to authenticate the identity of the account holder. A contactless card is used as an example of an identification device with an embedded microprocessor chip. A contactless card may be substituted for any other type of identification device that has identification information stored and which can be accessed for authenticating the account holder's identity. For example, the identification information can be stored using a magnetic strip, an embedded microchip, etc., or a combination thereof. The contactless card can take the form of a key, a storage device, an application (e.g., a mobile app), or any other form without limiting the technical aspects described herein. The contactless card can be used to provide authentication/identity when accessing bank accounts, payment accounts, transportation systems, hotel systems, password managers, computer accounts, or any other machine, building, restricted area, physical and/or digital files, and the like. As such, the disclosure is not intended to be limited to contactless cards and/or bank accounts. Furthermore, the exemplary use of “mobile device” throughout the application is only by way of example, and the reprogramming of a contactless card may also be performed with a personal computer, a tablet, a gaming system, a television, or any other device capable of reprogramming the contactless card using, for example near field communication protocol technology. Example embodiments discussed further herein use a “contactless card” and a “mobile device” as an exemplary combination of devices to describe the technical aspects of the embodiments without limiting the technical aspects.

Consider an example scenario where an account holder (i.e., user) loses her/his contactless card that stores the identification information of the account holder. The contactless card authenticates the account holder's identity based on authentication that can be performed via an enterprise server, e.g., a bank server, an identity service provider, or any other institution (“issuer”) that issues the contactless card. The authentication is provided based on one or more parameters associated with the account holder stored on the contactless card. Such parameters can include a unique identifier, a master key, biometric information, etc., or a combination thereof. The issuer keeps such parameters private and securely stored, e.g., on a server associated with the account holder's account. The account can be a bank account, an email account, a social media account, a password manager account, or any other type of account. Conventional techniques to provide the account holder the replacement card include the account holder requesting a replacement card from the issuer, e.g., via phone, website, chat, text messages, etc. The replacement card is then issued by programming the replacement card with one or more parameters associated with the account holder's identity. The replacement card is then shipped to the account holder from where it is programmed. Obtaining the replacement card is, thus, not immediate; rather, it can be at least a one-day process and generally spans several days. The delay is caused because of the technical challenge of programming the replacement card in a secure manner, which is generally performed by the issuer at a trusted site. The programmed replacement card then has to be shipped to the account holder.

Embodiments disclosed herein address such a technical challenge and provide techniques to facilitate the account holder to register a new contactless card (i.e., identification device) to the existing account dynamically, securely, and at a location where the account holder is at present. Accordingly, the time spent in requesting and shipping the replacement card can be eliminated, reducing the time required to obtain the replacement card. Accordingly, by providing techniques to dynamically and securely program a replacement card associated with an existing account, embodiments described herein provide a practical application, for example, in the field of manufacturing and providing contactless cards. Embodiments described herein are rooted in computing technology, particularly programming identification devices. Further, embodiments described herein provide an improvement to computing technology, particularly programming identification devices dynamically and securely.

Embodiments disclosed herein provide techniques to address one or more technical challenges. The technical challenges are related to securely accessing physical and/or digital resources, such as buildings, rooms, computers, documents, images, accounts, transactions, etc., associated with an account holder. Embodiments herein address such a technical challenge by using a contactless card, to authenticate and verify the user at the time of access. Further, embodiments described herein facilitate programming (as part of manufacturing) a replacement contactless card for the account holder in a dynamic and secure manner so that the account holder does not lose access to his/her resources for an extended period of time. Additional security can be provided in some embodiments by using a combination of the contactless card and a computing device (e.g., mobile). Accordingly, technical solutions and improvements are provided to increase the security of access and further programming contactless cards used to provide such access.

Embodiments herein are solutions to internet-centric challenges where authentication data is stored in servers (e.g., cloud platform) and has to be used to securely access physical/digital resources using a contactless card. By securely and dynamically programming a replacement contactless card, an account holder is not left without access for an extended period of time.

Several other improvements to technology, such as contactless cards, mobile devices, and servers, to facilitate secure programming of contactless cards and advantages in such technical areas will be apparent to a person skilled in the art based on the description herein.

While the above example describes a scenario where the contactless card is lost, it is understood that the account holder may wish to get the replacement card for any other reason apart from the loss of the original card. For example, the account holder may want a second card, an add-on card for another user, etc.

With general reference to notations and nomenclature used herein, the detailed descriptions herein may be presented in terms of program procedures executed on a computer or network of computers. These procedural descriptions and representations are used by those skilled in the art to effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other but yet still co-operate or interact with each other.

Various embodiments also relate to apparatus or systems for performing these operations. This apparatus may be specially constructed for the required purpose, or it may comprise a computer as selectively activated or reconfigured by a computer program stored in the computer. The procedures presented herein are not inherently related to a particular computer or other apparatus. Various machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. However, novel embodiments can be practiced without these specific details. In other instances, structures and devices are shown in block diagram form in order to facilitate a description thereof. The intention is to cover all modifications, equivalents, and alternatives consistent with the claimed subject matter.

In the Figures and the accompanying description, the designations “a,” “b,” and “c” (and similar designators) are intended to be variables representing any positive integer. Thus, for example, if an implementation sets a value for a=5, then a complete set of components 123 illustrated as components 123-1 through 123-a (or 123a) may include components 123-1, 123-2, 123-3, 123-4, and 123-5. The embodiments are not limited in this context.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

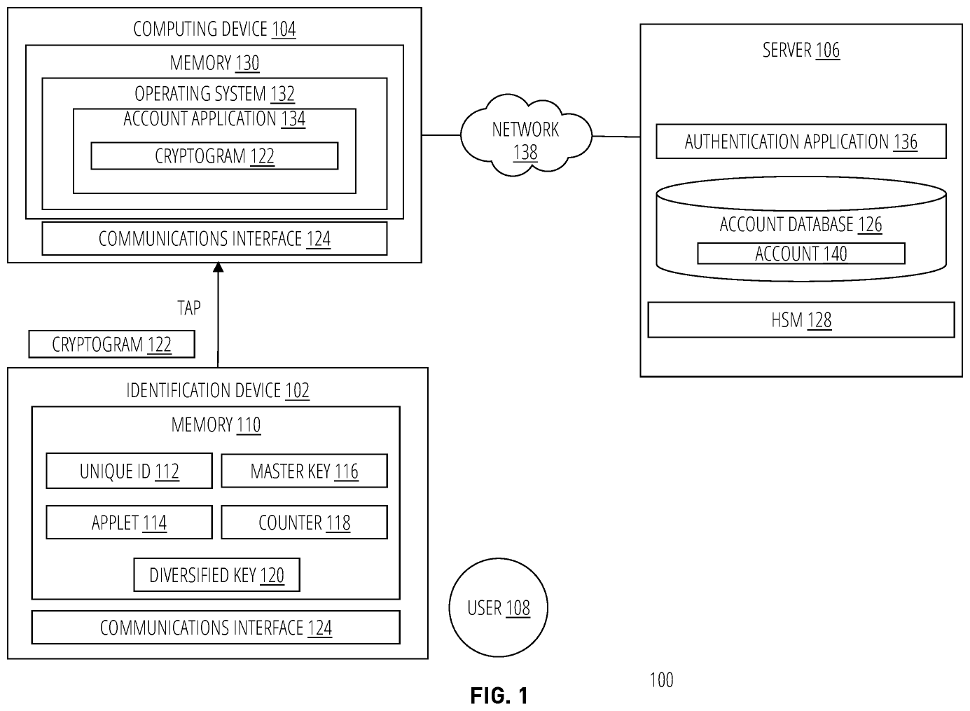

FIG. 1 depicts an exemplary system 100, also referred to as a computing architecture, consistent with disclosed embodiments. Although system 100 shown in the Figures herein has a limited number of elements in a certain topology, it may be appreciated that the system 100 may include more or fewer elements in alternate topologies as desired for a given implementation.

The system 100 comprises one or more contactless cards 102, one or more computing devices 104, one or more servers 106, and one or more printers 704.

The contactless card 102 is representative of any type of security key, card (e.g., a credit card, debit card, automated teller machine (ATM) card, gift card, payment card, smart card, identification card, etc.), and the like that can be used to authenticate a user 108. The contactless card 102 is associated with an account 140 of the user 108. The account 140 can be a financial account, a social media account, an employee account, a customer loyalty account (e.g., airline, hotel, restaurant, store, etc.), or any other account associated with the user 108. The user 108 may perform one or more operations using the account 140, and or associated with the account 140. For example, in the case of a financial account, the user 108 may conduct transactions such as money transfers, check deposits, bill payments, balance inquiries, reaching customer service, accessing one or more documents, etc. In the case of an employee account, the user 108 may conduct operations such as sending/receiving messages, editing documents/records, operating machinery, etc., or any other operations that the user 108 may be expected to perform as part of his/her employment. Messages can be emails, instant messages, or any other type of message. In the case of a loyalty account, the user 108 may perform operations such as purchases, returns, statement inquiries, receipt inquiries, accessing coupons, etc. Further yet, the user 108 may be able to access one or more resources, e.g., files, documents, data streams, rooms, doors, etc., based on the account 140. It is understood that the account 140 can be any type of account and is not limited to the types of accounts listed herein.

The contactless card 102 facilitates authenticating the user 108 to use the account 140. Here, “using” the account 140 can include any operation performed associated with the account 140. For example, using the account can include performing one or more operations associated with the account 140, such as logging into the account 140, accessing resources associated with the account 140, etc. In addition, using the account 140 can include accessing and/or changing one or more settings of the account 140. For example, the settings can include usernames, passwords, demographic information (age, address, gender, etc.), biometric identifiers, financial information (e.g., debt limit, transaction limits, etc.), notification settings (e.g., a condition when to generate and send notifications to user 108), etc. The settings can also include access permissions that provide/limit the user's 108 access to one or more physical/digital resources associated with the account 140. The physical resources can include doors, safes, computers, cabinets, devices (e.g., printers, projectors, etc.), apparatus (e.g., lab apparatus, etc.), or any other such resources. Digital resources can include files, computers, other user accounts, databases, etc. Based on the access permissions of the user 108 specified by the account 140, he/she may or may not be authorized to access one or more of the resources (physical/digital). The contactless card 102 addresses the challenge of authenticating the user 108 as described herein.

The account 140 is maintained by the account provider/issuer (not shown) via one or more servers 106. The account provider of the account 140 can be a financial institution (e.g., bank, credit union, etc.), an employer, a social media platform, an airline, a restaurant, a hotel, a retailer, or any other entity. The account provider stores information associated with the account 140 using a server 106. The server 106 is a computer server, such as a mainframe computer, a server cluster, a distributed computing server, etc. It is understood that although a single server is depicted, the server 106 can include several computing devices that operate together.

As shown, the server 106 includes an authentication application 136 and an account database 126. The account database 126 generally includes information related to one or more accounts, (e.g., account 140), one or more users (e.g., user 108), and one or more contactless cards 102 of the account 140. The account 140 includes the permissions, settings, and other information that facilitates the user 108 to use the account 140 with the contactless card 102. Further, the user 108 can use the account 140 via the computing device 104. In some embodiments, the user 108 can use the account 140 via a combination of the contactless card 102 and the computing device 104. For example, the combination of the contactless card 102 and the computing device 104 is used to perform a multi-factor authentication (MFA) of the user 108. Embodiments described herein accordingly address a technical challenge of authenticating access to the account 140, which is an electronic account. Embodiments herein, accordingly, address internet-centric, digital-account-centric challenges in a practical manner. The challenges are addressed using specific computer components that facilitate authenticating the user 108 by performing a specific sequence of operations.

The computing device 104 is representative of any number and type of computing devices, such as smartphones, tablet computers, wearable devices, laptops, portable gaming devices, virtualized computing systems, merchant terminals, point-of-sale systems, servers, desktop computers, and the like. A mobile device may be used as an example of the computing device 104, but it should not be considered to limit the disclosure. The server 106 is representative of any type of computing device, such as an enterprise server, workstation, compute cluster, cloud computing platform, virtualized computing system, and the like. Although not depicted for the sake of clarity, the computing device 104, contactless card 102, and server 106 each include one or more memory devices (e.g., random access memory, storage drives, etc.), one or more processor circuits (central processing unit, graphics processing unit, floating point unit, etc.), to execute programs, code, scripts, and other types of computer-executable instructions.

The contactless card 102 includes one or more communications interfaces 124, such as a radio frequency identification (RFID) chip configured to communicate with a communications interface 124 (also referred to herein as a “reader”, “card reader”, a “wireless card reader”, and/or a “wireless communications interface”) of the computing devices 104. The communications interfaces 124 may facilitate wireless communication via near field communication (NFC), using the Europay, Mastercard, and VISA standard (EMV), or other short-range protocols in wireless communication. Although NFC is used as an example communications protocol herein, the disclosure is equally applicable to other types of wireless communications, such as Bluetooth™, Bluetooth Low Energy (BLE), and/or Wi-Fi™, etc.

As shown, a memory 110 of the contactless card 102 includes a unique ID 112, an applet 114, one or more master keys 116, a counter 118, and one or more diversified keys 120. The unique ID 112 may be any identifier that uniquely identifies the contactless card 102 relative to other contactless cards 102. In some examples, the unique ID 112 may be an identifier that uniquely identifies user 108 with whom the contactless card 102 is associated. The applet 114 is executable code (i.e., computer-executable instructions) configured to perform some or all of the operations described herein. The counter 118 is a value that is synchronized between the contactless card 102 and server 106. The counter 118 may comprise a number that changes each time data is exchanged between the contactless card 102 and the server 106 (and/or the contactless card 102 and the computing device 104). The counter 118, master keys 116, diversified keys 120, and/or unique ID 112 are used to provide security in the system 100, as described in greater detail below. The memory 110 can include additional components, such as an operating system, images, etc., which are not depicted herein for brevity.

As shown, a memory 130 of the computing device 104 includes an instance of an operating system 132. Example operating systems include the Android® operating system (OS), iOS®, macOS®, Linux®, and Windows® operating systems. As shown, the operating system 132 includes an account application 134. The account application 134 allows the user 108 to perform various account-related operations, such as viewing account balances, purchasing items, processing payments, accessing one or more resources, printing documents, and the like. The account application 134 is a computer program including one or more computer-executable instructions. In some embodiments, the account application 134 can include computer-executable instructions that are specific to the operating system 132 and/or the computing device 104. Alternatively, or in addition, the account application 134 includes computer-executable instructions that can be executed across different operating systems and computing devices. In some embodiments, the account application 134 may be a web browser that allows the user 108 to access the account 140 via one or more web pages of the account 140. The web pages of the account 140 may by hosted by the server 106 (or another hosting entity). The account application 134 accesses the account 140 to confirm the user's 110 identity to access the physical and/or digital resources.

In some embodiments, the user 108 accesses the account 140 on the server 106 via the account application 134 on the computing device 104 after authenticating using authentication credentials. For example, the authentication credentials may include a username (or login) and password, biometric credentials (e.g., fingerprints, Face ID, palmprints, iris scans, etc.), and the like. In some embodiments, such authentication credentials-based access only facilitates the user 108 to access a subset of features/resources of the account 140. For example, in the case of a financial account, the account application 134 may limit the user 108 to only view certain balances and/or information but not permit the user to perform operations, such as a money transfer. In the case of a loyalty account, the user 108 may be prohibited from purchasing at such a first level of authentication that provides access to the subset of features/resources. In the case of an employee account, the user 108 may be prohibited from viewing emails, accessing certain premises, etc. For accessing such prohibited (or secured second level) features of the account 140, the user 108 has to be authenticated using the contactless card 102.

In some embodiments, the user 108 is authenticated using a gesture-based authentication using the contactless card 102. For example, the user 108 may tap the contactless card 102 to the computing device 104 (or otherwise bring the contactless card 102 within communications range of the communications interface 124 of the computing device 104 104). The account application 134 may then instruct the applet 114 to generate a cryptogram 122. The cryptogram 122 may be generated based on any suitable cryptographic technique. In some embodiments, the cryptogram 122 may be based on the unique ID 112 of the contactless card 102. The contactless card 102 transmits the cryptogram 122 to the account application 134 via the communications interfaces 124. In some cases, wireless communication using NFC is performed by the communications interfaces 124. In some embodiments, the applet 114 may include the cryptogram 122 and an unencrypted identifier (e.g., the counter 118, the unique ID 112, and/or any other unique identifier) as part of a transmitted data package, including the cryptogram 122. In at least one embodiment, the data package is a near field data exchange (NDEF) file.

In some embodiments, the system 100 is configured to implement key diversification to secure the communicated data, which may be referred to as a key diversification technique herein. Generally, the server 106 and the contactless card 102 may be provisioned with the same master key 116 (also referred to as a master symmetric key). More specifically, each contactless card 102 is programmed with a distinct master key 116 that has a corresponding pair in the server 106. For example, when a contactless card 102 is manufactured, a unique master key 116 may be programmed into the memory 110 of the contactless card 102. Similarly, the unique master key 116 may be stored in a record of the user 108 associated with the contactless card 102 in the account database 126 of the server 106 (and/or stored in a different secure location, such as the hardware security module (HSM) 128). The master key 116 may be kept secret from all parties other than the contactless card 102 and server 106, thereby enhancing the security of the system 100. In some embodiments, the applet 114 of the contactless card 102 may encrypt and/or decrypt data (e.g., the unique ID 112) using the master key 116 and the data as input in a cryptographic algorithm. For example, encrypting the unique ID 112 with the master key 116 may result in the cryptogram 122. Similarly, the server 106 may encrypt and/or decrypt data associated with the contactless card 102 using the corresponding master key 116. Because the server 106 and the contactless card 102 have the same master key 116, by using the same cryptographic algorithm, the two generate matching cryptograms 122.

Accordingly, the user 108 can be authenticated by matching the cryptograms 122 generated by the contactless card 102 and the server 106. In some embodiments, the computing device 104 transmits the cryptogram 122 received from the contactless card 102 to the server 106. The server 106 verifies authentication of the users 108 by comparing the received cryptogram 122 with the cryptogram 122 generated by the server 106. The server 106 sends a notification indicative of the success of the verification to the computing device 104. If the cryptograms 122 match, the server 106 indicates that the verification was successful. Otherwise, the server 106 indicates that the verification was unsuccessful. The server 106 can communicate the notification to the computing device 104 via the network 138, for example.

In some embodiments, the verification may use additional information apart from the cryptogram 122. Alternatively, or in addition, the cryptogram 122 is generated using data in addition to the unique ID 112. In some embodiments, the master keys 116 of the contactless card 102 and server 106 may be used in conjunction with the counters 118 to enhance security using key diversification. The counters 118 comprise values that are synchronized between the contactless card 102 and server 106. For example, the counters 118 may comprise a number that changes each time data is exchanged between the contactless card 102 and the server 106 (and/or the contactless card 102 and the computing device 104). Here, data exchanged between the contactless card 102 and the server 106 and/or the computing device 104 can include instructions and responses passed between the contactless card 102 and the other device. For example, the applet 114 may provide the master key 116, the unique ID 112, and a diversification factor as input to a cryptographic algorithm, thereby producing a diversified key 120. In some embodiments, the diversification factor is the counter 118. The diversified key 120 may then be used to encrypt some data, such as the diversification factor (e.g., the counter 118) or other sensitive data. The applet 114 and the server 106 may be configured to encrypt the same data to facilitate the decryption and/or verification processing of the cryptogram 122.

In some embodiments, when preparing to send data (e.g., to the server 106 and/or the computing device 104), the applet 114 of the contactless card 102 may increment the counter 118. The applet 114 of the contactless card 102 may then provide the master keys 116, unique ID 112, and counter 118 as input to a cryptographic algorithm, which produces a diversified key 120 as output. The cryptographic algorithm may include encryption algorithms, hash-based message authentication code (HMAC) algorithms, cipher-based message authentication code (CMAC) algorithms, and the like. Non-limiting examples of the cryptographic algorithm may include a symmetric encryption algorithm, such as 3DES or AES107; a symmetric HMAC algorithm, such as HMAC-SHA-256; and a symmetric CMAC algorithm, such as AES-CMAC. Examples of key diversification techniques are described in greater detail in U.S. patent application Ser. No. 16/205,119, filed Nov. 29, 2018. The aforementioned patent application is incorporated by reference herein in its entirety.

The applet 114 may then encrypt some data (e.g., the unique ID 112, the counter 118, a command, and/or any other data) using the diversified key 120 as input to the cryptographic algorithm. For example, encrypting the unique ID 112, the diversified key 120 may result in an encrypted unique ID 112 (e.g., a cryptogram 122).

In some embodiments, two diversified keys 120 may be generated, e.g., based on one or more portions of the input to the cryptographic function. In some embodiments, the two diversified keys 120 are generated based on two distinct master keys 116, the unique ID 112, and the counter 118. In such embodiments, a message authentication code (MAC) is generated using one of the diversified keys 120, and the MAC may be encrypted using the other one of the diversified keys 120. The MAC may be generated based on any suitable data input to a MAC algorithm, such as sensitive data, the unique ID 112, the counter 118, etc. The applet 114 and the server 106 may be configured to generate the MAC based on the same data. In some embodiments, the cryptogram 122 is included in a data package such as an NDEF file. The account application 1310 may then read the data package, including cryptogram 122, via the communications interface 124 of the computing device 104.

The account application 134 transmits the cryptogram 122 to the server 106. The server 106 may provide the cryptogram 122 to the authentication application 136 and/or the HSM 128 for verification based at least in part on the instance of the master key 116 stored by the server 106. In some embodiments, the authentication application 136 and/or the HSM 128 may identify the master key 116 and counter 118 using the unencrypted unique ID 112 provided to the server 106. In examples where additional data is used to generate the cryptogram 122, the server 106 may identify the additional data in the account database 126 and/or HSM 128 using the unencrypted unique ID 112. In some examples, the authentication application 136 may provide the master key 116, unique ID 112, and counter 118 as input to the cryptographic function of the HSM 128, which produces one or more diversified keys 120 as output. In other embodiments, the server 106 encrypts the master key 116, unique ID 112, and any additional data to generate the diversified keys 120. The resulting diversified keys 120 may correspond to the diversified keys 120 of the contactless card 102. The generated diversified keys 120 are used to decrypt the cryptogram 122 and/or verify the MAC once decrypted. For example, the server 106 may generate a MAC based on the same data as the applet 114, e.g., the sensitive data, the unique ID 112, the counter 118, and/or any additional data. If the MAC generated by the server 106 matches the decrypted MAC in the cryptogram 122, the server 106 may verify or otherwise successfully authenticate the cryptogram 122.

Regardless of the decryption technique used, the authentication application 136 and/or the HSM 128 may successfully decrypt the cryptogram 122 and verify the MAC, thereby verifying or authenticating the cryptogram 122. If the decryption and/or MAC verification is successful, the authentication application 136 and/or the HSM 128 may generate and transmit a notification indicative that the user 108 has been authenticated. If the authentication application 136 is unable to decrypt the cryptogram 122 (and/or is unable to verify the MAC) the authentication application 136 does not validate the cryptogram 122. In such an example, the authentication application 136 determines to refrain from generating and transmitting a notification. The authentication application 136 may transmit an indication of the failed decryption and/or verification to the computing device 104.

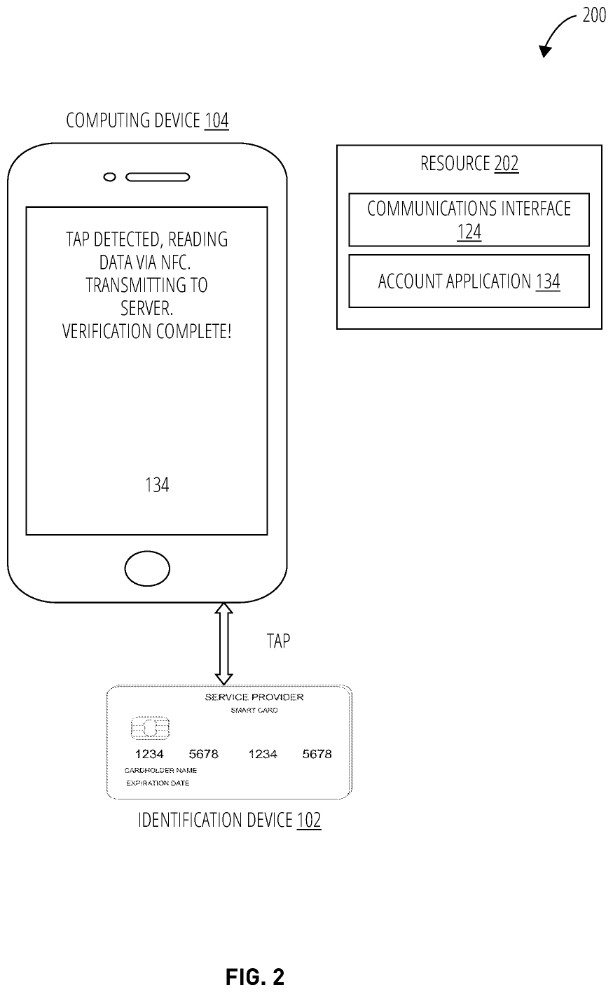

FIG. 2 is a schematic 300a illustrating an embodiment where a contactless card 102 is used to authenticate the identity of the user 108 according to one or more embodiments. Several different interactions can be used.

In one example, the contactless card 102 is tapped to the computing device 104 for the computing device 104 to obtain the cryptogram 122. The contactless card 102 based on the tap gesture, causes the applet 114 to generate a cryptogram (e.g., the cryptogram 122). The cryptogram 122 and any other data (e.g., unencrypted unique ID 112) may be included in a data package, such as an NDEF file, which is read by the computing device 104. The computing device 104 may then transmit the cryptogram 122 (and other data) to the server 106 for verification (e.g., decryption and/or MAC verification) as described herein. In some embodiments, the computing device 104 communicates with a resource 202. The communication can be via a communications interface 124 of the resource, e.g., in a wired and/or wireless manner. The resource 202 can be physical (computer, room, etc.), digital (files, data stream, account, etc.), or a combination thereof (e.g., digital files on a computer stored in a room). The computing device 104 communicates with the resource 202 to indicate that the user 108 has been authenticated based on the contactless card 102.

In another example, the contactless card 102 is tapped to the resource 202. The applet 114 generates the cryptogram 122 in response. In some embodiments, the resource 202 may include the account application 134. The resource 202 may then transmit the cryptogram 122 (and other data) to the server 106 for verification (e.g., decryption and/or MAC verification) as described herein. Upon successful verification by the server 106 of the data sent by the resource 202, the resource 202 lets the user 108 further access. In yet other examples, the tapping of the contactless card 102 to the resource 202 causes the contactless card 102 to communicate with the computing device 104 to complete the user 108's identity verification as described herein.

Once the user 108's identity is verified using the contactless card 102, the user 108 gains access to the resource 202. If the user 108 loses, forgets, misplaces, etc., the contactless card 102, the user 108 may not be able to access the physical and/or digital resource 202. A technical challenge exists in creating a replacement (second) contactless card 102 in a secure and dynamic manner, without significant delays, such as caused by shipping the replacement contactless card 102. Embodiments described herein facilitate creating the replacement contactless card 102 and addressing the technical challenge. In some embodiments, the replacement contactless card 102 may be a permanent replacement of the original (first) contactless card 102 that the user 108 is missing. In such a case, the original contactless card 102 is deactivated upon the creation of the replacement contactless card 102.

Alternatively, the replacement contactless card 102 is a temporary contactless card 102. The replacement contactless card 102 is designated to only operate until the original contactless card 102 is found and used again. The replacement contactless card 102 is deactivated once the original contactless card 102 is found. In some embodiments, the replacement contactless card 102 is programmed to deactivate automatically upon passage of a certain duration. Alternatively, or in addition, the replacement contactless card 102 is programmed to deactivate automatically upon a predetermined number of uses. Automatic deactivation of the replacement contactless card 102 may be programmed for other factors in some other embodiments.

In one or more embodiments, the user 108 may have a first contactless card 102 and create a second contactless card 102 based on the first contactless card 102. For example, the second contactless card 102 may be created for an authorized user, e.g., family member, friend, employee, contractor, colleague, etc. As noted earlier, a technical challenge exists to create the second contactless card 102 in a secure and dynamic manner, without significant delays, such as caused by shipping the second contactless card 102.

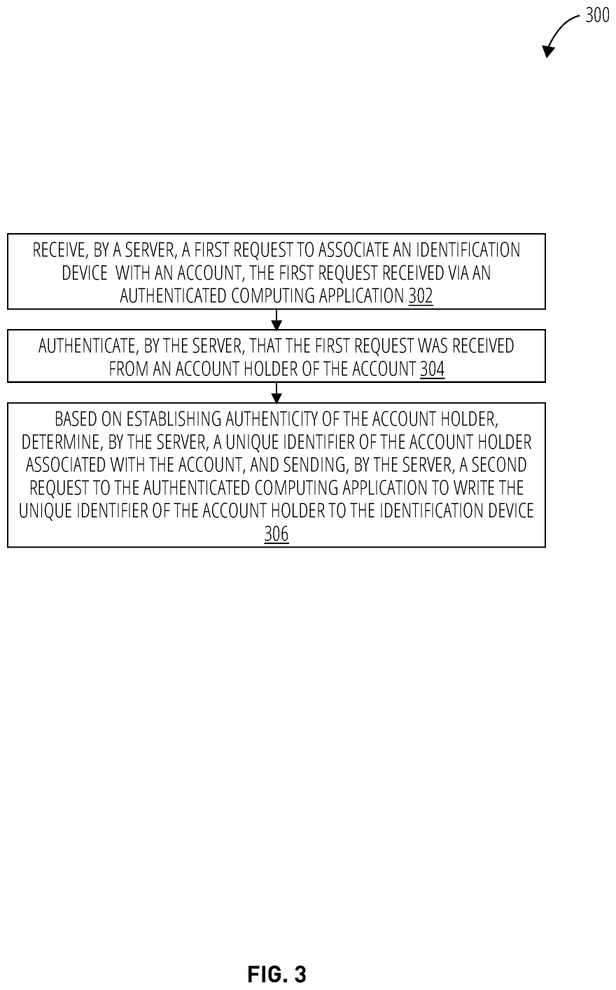

FIG. 3 illustrates an example method 300 for programming and associating a replacement contactless card with an existing account according to one or more embodiments. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

Consider that the user 108 does not have his/her contactless card 102 available. For example, the user 108 may have lost, misplaced, forgotten, etc., the contactless card 102. Instead, the user 108 may be able to obtain a replacement contactless card 102. For example, the user 108 may purchase the replacement contactless card 102. Alternatively, the user 108 may be provided the replacement contactless card 102, for example, by another user, such as a customer service representative, an administrator, etc. The replacement contactless card 102 can be provided to the user 108 substantially instantaneously once he/she realizes that the original contactless card 102 is not available. In some embodiments, the user 108 purchases the replacement contactless card 102 at a store, a vending machine, a bank branch, an ATM machine, etc. The method 300 facilitates programming the replacement contactless card 102 dynamically and securely so that the replacement contactless card 102 can be used to authenticate the user 108.

In some embodiments, at block 302, the server 106 receives, a first request to associate the replacement contactless card 102 with the account 140. The first request is received via the account application 134. For example, the user 108 logs in to the account application 134 via the computing device 104. In some embodiments, logging in to the account application 134 requires the user 108 to provide credentials such as username and password. In addition, or alternatively, the user 108 may provide biometrics, such as fingerprint, face-id, iris, voice, palm, or any other such biometric identifier to log in to the account application 134. Additionally, or alternatively, the log in process may require a multi-factor authentication, where the user 108 has to provide a one-time password (OTP), such as a pin, a code, etc. The OTP may be received via a text message, an email, another application (e.g., an authenticator application), etc. Once the user 108 logs in to the account application 134, he/she can send the first request to the server 106 to program the replacement contactless card 102. For example, the user 108 can send the request using a menu option, a chat instruction, a voice command, etc. In other embodiments, instead of the account application 134, the first request is sent via a chat message, a text message, a phone call, or other communication techniques.

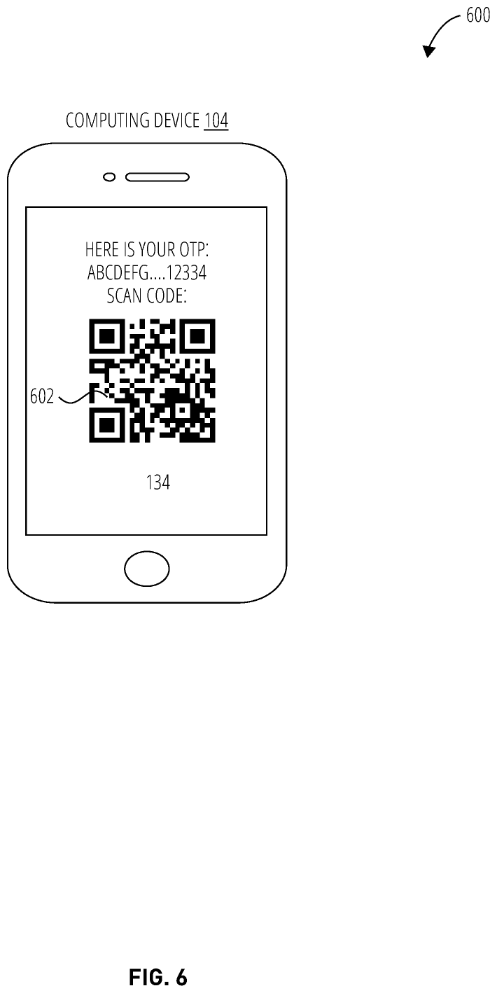

In block 304, the server 106 authenticates that the first request was sent by the user 108, who is the account holder of the account 140. In some embodiments, the server 106 can perform such authentication of the user 108 by sending an OTP to the computing device 104. FIG. 6 depicts an example where an OTP 602 is provided to the user 108 via the account application 134. The user 108 authenticates herself/himself by providing at least some portion of the OTP 602 back to the server 106. In some embodiments, the OTP 602 is machine-readable. The user 108 may have to send the machine-readable OTP 602 back to the server 106 to assure the server 106 that the first request was indeed sent from the computing device 104. In other embodiments, the OTP 602 may be sent to the user 108 to the computing device 104 via a second application, different from the account application 134. For example, the OTP 602 can be sent via a text message, an email, a chat message, etc. The user 108 may have to provide at least a portion of the OTP 602 from the second application to the server 106 via the account application 134. The OTP 602, although depicted as a 2-dimensional QR code in FIG. 6, can take other forms. For example, the OTP 602 can be a pin code, an alphanumeric string, an image, or any other type of authentication code.

In addition, or alternatively, the server 106 authenticates that the first request was sent by the user 108 by sending a questionnaire (i.e., one or more questions) to the user 108 to answer. The questionnaire may be dynamically created by the server 106. For example, the server 106 uses information associated with the user 108 from the account 140 to create the questionnaire. The questionnaire can include but is not limited, for example, the user 108's address, assets (e.g., bank accounts, property, etc.), family (e.g., spouse's name, mother's name, etc.), employment (present employer, past employer, etc.), and other such aspects of the user 108 known and stored in association with the account. In some embodiments, the server 106 also includes questions that are not relevant to the user 108's account, such as questions about the user's bank accounts, loans, etc., that are not associated with the account 140. In some embodiments, the server 106 creates at least some of the questionnaire based on information from web-based content associated with the user 108 available from other websites and/or repositories. For example, the server 106 may access data repositories, such as government, governmental agencies, department of motor vehicles, social media, websites, etc., to obtain information about the user 108 and generate the questions. At least some of the questions can include multiple-choice questions in some embodiments. In some embodiments, the questionnaire can include questions that are based on sensitive information that is generally protected as secret by the user 108. For example, such questions can ask the user 108 to provide a security word or code that the user 108 has preconfigured with the account 140, a social security number, or other identifiers that are uniquely associated with the user 108 and known to the issuer, an ATM pin associated with the user 108's transaction card associated with the account 140, etc. In one or more embodiments, the questionnaire is generated dynamically using artificial intelligence/machine-learning models, such as generative adversarial networks. In some embodiments, the server 106 creates a query to generate the questionnaire for the user 108 by providing one or more identifying elements associated with the user 108. The identifying elements can include the users 108's name, for example. In addition, the query may include one or more data repositories to be used to create the questionnaire. In some embodiments, the server 106 may deem the users 108 as being authenticated based on at least a predetermined number or proportion (e.g., 3, 5, 50%, 100%, etc.) of the questions in the questionnaire being answered accurately.

Additionally, or alternatively, the server 106 authenticates that the first request was sent by the user 108 by sending a link to the user 108 that the user 108 has to access within a predetermined duration (e.g., 5 minutes, 10 minutes, 15 minutes, etc.). The accessed link may be to a dynamically created resource, such as a webpage. The resource may not be publicly accessible apart from using the link. Similar to the OTP 602, the link may be sent via the computing device 104 itself, for example, through the account application 134, a second application (different from the account application 134). Alternatively, the link may be sent for the user 108 to access via another device (different from the computing device 104). In some embodiments, responsive to the resource at the link being accessed the server 106 deems that the user 108 has been authenticated. In some embodiments, the linked resource includes the questionnaire, and the server 106 deems the user 108 being authenticated upon the at least a predetermined number or proportion (e.g., 3, 5, 50%, 100%, etc.) of the questions in the questionnaire being answered accurately.

In block 306, responsive to establishing the authenticity of user 108, the server 106 identifies a unique identifier of the user 108 associated with the account 140. In some embodiments, the unique identifier can be the unique ID 112 that was stored in the original contactless card 102 (that is not available). In some embodiments, the unique identifier is a combination of the unique ID 112, the counter 118, and the master key 116 from the original contactless card 102. For example, the unique ID 112 and the counter 118 can be used as the unique identifier in some embodiments. Any other combination can be used in other embodiments.

In some embodiments, the server 106 generates a new unique ID 112 for the user 108. The server 106 stores the new unique ID 112 in the account 140. Alternatively, the server 106 uses a unique ID 112 that may be associated with a second contactless card 102 of the same user 108 as the new unique ID 112. For example, if a bank (issuer) has issued two transaction cards to the user 108, of which a first transaction card is unavailable (and being replaced), the bank may use the unique ID 112 associated with the second transaction card as a new unique ID 112 for the replacement transaction card.

The server 106 marks the original unique ID 112 as being discarded in some embodiments. Alternatively, or in addition, the server 106 deletes the original unique ID 112 and replaces it with the new unique ID 112. The new unique ID 112 is then provided as part of the unique identifier to the account application 134.

The server 106 sends a request (second request) to the account application 134 to write the unique identifier of the user 108 to the replacement contactless card 102. In some embodiments, the server 106 sends the request and the unique identifier as a single communication to the account application 134. In other embodiments, the server 106 can divide the communication into two or more communications to provide the request and the unique identifier separately. Additional partitioning of the information can be performed to enhance the security further.

In some embodiments, the request can include, or prior to the request, another request is sent to the account application 134 to cause the user 108 to bring the replacement contactless card 102 within a predetermined proximity of the computing device 104. For example, the predetermined proximity can be within a near field communication range that facilitates the account application 134 to initiate a write request to store the unique identifier to the contactless card. In some embodiments, the account application 134 shows a notification requesting the user 108 to perform a gesture with the replacement contactless card 102 in relation to the computing device 104; for example, tapping the replacement contactless card 102 to the computing device 104. Upon detecting the replacement contactless card 102 within the predetermined proximity, the account application 134 writes the unique identifier to the replacement contactless card 102 using the near field communication protocol.

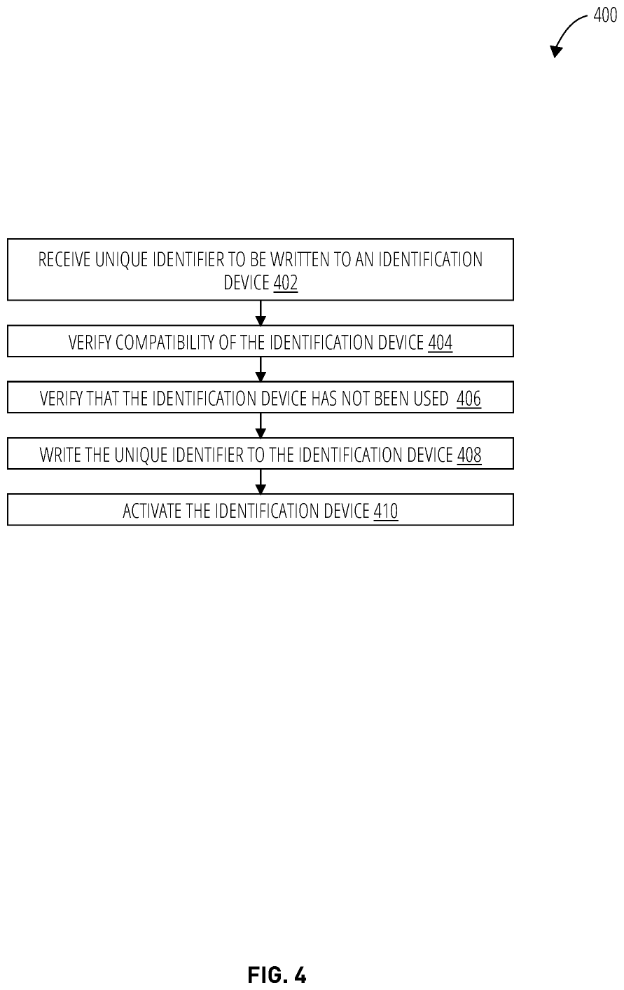

FIG. 4 illustrates an example method 400 for programming a replacement contactless card according to one or more embodiments. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some examples, the method includes receiving a unique identifier to be written to a contactless card at block 402. The unique identifier is received from the server 106 in some embodiments. (see FIG. 3).

According to some examples, the method includes verifying the compatibility of the replacement contactless card at block 404. Checking the compatibility can include ensuring that the replacement contactless card 102 includes at least a particular version of hardware and/or software. The check can include sending, by the account application 134, one or more requests to the replacement contactless card 102 via the near field communication protocol to determine the version. Alternatively, or in addition, the checking can include checking, by the account application 134, that the replacement contactless card 102 is compatible with the issuer of the account 140. For example, if the account 140 is a bank account, the replacement contactless card 102 may have to be obtained from a location that is authorized by the issuer, i.e., bank. To check such compatibility, the account application 134 may check if the replacement contactless card 102 has a particular identification code associated with the issuer. The identification code can be an alphanumeric string, a hash key, a public key, a digital signature, etc. The identification code can be stored in the memory 110 of the replacement contactless card. Alternatively, or in addition, the account application 134 checks the compatibility of the replacement contactless card 102 based on the presence of an applet 114 associated with the issuer on the replacement contactless card 102.

In some embodiments, the replacement contactless card 102 may be a generic contactless card 102, and not specific to the issuer of the account 140. In some embodiments, writing the unique identifier to the replacement contactless card 102 includes writing the identification code associated with the issuer to the replacement contactless card 102. This may prevent the replacement contactless card 102 from being reused for a different issuer. Alternatively, or in addition, the writing of the unique identifier to the replacement contactless card 102 can include writing the applet 114 to the replacement contactless card 102. The account application 134 receives the identification code and/or the applet 114 to be written to the replacement contactless card 102 from the server 106 in some embodiments.

According to some embodiments, the method includes verifying that the replacement contactless card has not been used before at block 406. The account application 134 reads, from the replacement contactless card 102, using near field communication protocol, an identifier of the replacement contactless card 102. For example, the identifier of the replacement contactless card 102 can include a MAC address or any other hardware-related information. Alternatively, or in addition, the identifier can be a number (e.g., 16-digit code, 20-digit code, etc.) that may or may not be visible on the replacement contactless card 102. In some embodiments, the account application 134 notifies the user 108 to enter such an identifier manually via an interface on the computing device 104. The account application 134, upon receiving the identifier, may send the identifier to the server 106. The server 106, in turn, checks that the identifier has not been used, i.e., associated with any other account 140 accessible by the server 106. The server 106 sends a notification to the account application 134 indicative of whether or not the identifier was found to be associated with previously used contactless cards.

According to some embodiments, the method includes writing the unique identifier to the replacement contactless card 102 at block 408. The unique identifier is written to the replacement contactless card 102 upon verifying the compatibility and that the replacement contactless card 102 is not previously used. The account application 134 writes the unique identifier to the replacement contactless card 102 using near field communication protocol. In some embodiments, the unique identifier is written at specific memory locations in the replacement contactless card 102. The memory locations may be specified by the server 106 in some embodiments.

According to some embodiments, the method 400 includes activating the replacement contactless card 102 at block 410. In some embodiments, writing the unique identifier to the replacement contactless card 102 activates the replacement contactless card 102. Alternatively, or in addition, an indicator on the replacement contactless card 102 is updated or written to indicate that the replacement contactless card 102 is now activated. The indicator can be a flag (e.g., integer, byte, bit, etc.) stored on the replacement contactless card 102. The flag may be stored at a particular location in the memory 110.

In some embodiments, the replacement contactless card 102 is activated only for a limited duration (e.g., 1 day, 15 days, 1 month, etc.). The limit on the activation may be stored on the replacement contactless card 102. For example, an expiration date and time may be stored on the replacement contactless card 102. The expiration date and time may also be stored by the server 106 in association with the account 140. In other embodiments, the expiration may also be linked with a limited number of uses of the replacement contactless card 102. For example, the counter 118 may be used to limit the number of uses of the replacement contactless card 102 by setting a maximum use threshold. The maximum use threshold may be stored on the replacement contactless card 102 and/or in association with the account 140.

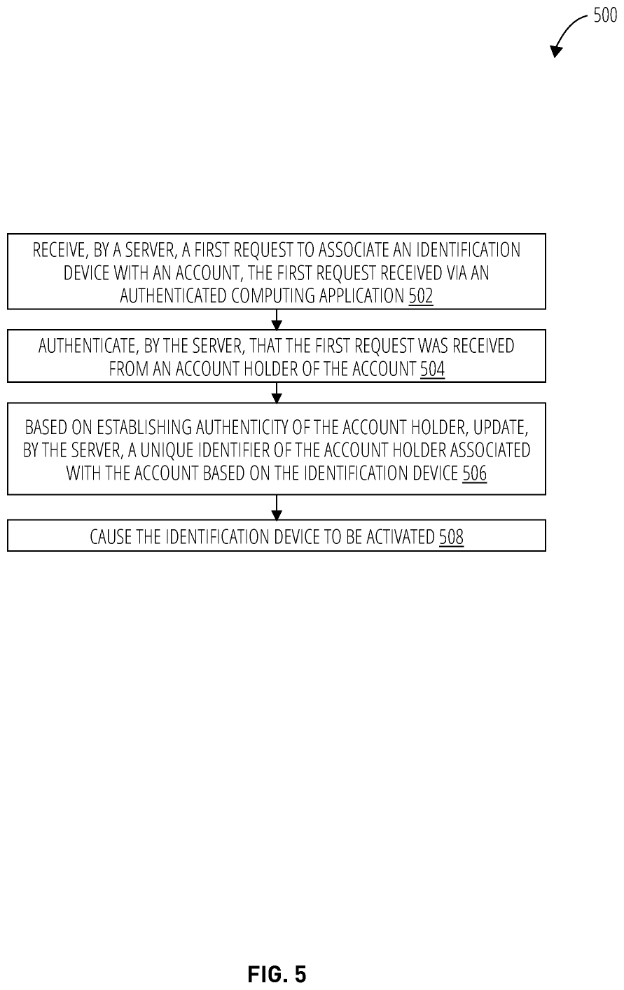

FIG. 5 illustrates an example method 500 for programming a replacement contactless card and associating it with an existing account according to one or more embodiments. Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

Again, consider the scenario where the user 108 does not have his/her contactless card 102 available, and he/she obtains a replacement contactless card 102 that is to be programmed and associated with his/her account 140.

According to some embodiments, at block 502, the method 500 includes receiving, by the server 106, the first request to associate the replacement contactless card 102 with the account 140. The first request is sent via the authenticated account application 134. In other embodiments, the request is sent via a chat message, a text message, a phone call, or other communication techniques.

According to some embodiments, the method 500 further includes authenticating by the server 106 that the first request was received from the user 108, who is an account holder of the account at block 504. The authentication is performed as described elsewhere herein (e.g., see block 304).

According to some embodiments, the method 500 further includes, based on establishing the authenticity of the account holder, updating, by the server 106, a unique identifier of the user 108 associated with the account 140 based on information of the replacement contactless card 102 at block 506. For example, the update includes sending, by the server 106, a request to the account application 134 to cause the user 108 to bring the replacement contactless card 102 within a predetermined proximity of the computing device 104. For example, the predetermined proximity can be within a near field communication range that facilitates the account application 134 to initiate a read request to read the unique ID 112 stored on the replacement contactless card 102. In some embodiments, the account application 134 shows a notification requesting the user 108 to perform a gesture with the replacement contactless card 102 in relation to the computing device 104; for example, tapping the replacement contactless card 102 to the computing device 104. Upon detecting the replacement contactless card 102 within the predetermined proximity, the account application 134 determines if the replacement contactless card 102 is compatible with the account 140. The compatibility can be determined as described elsewhere herein, based on one or more read requests. (e.g., see block 404).

Further, once the authenticity of the user 108 and the compatibility of the replacement contactless card 102 are verified, the account application 134 reads the unique ID 112 from the replacement contactless card 102 using the near field communication protocol.

The account application 134, via the computing device 104, sends the unique ID 112 from the replacement contactless card 102 to the server 106. The server 106 updates the existing (original) unique ID 112 associated with the account 140 with the new unique ID 112 from the replacement contactless card 102. The server 106 sends a notification to the account application 134 of the update, which, in turn, causes the account application 134 to show a notification to the user 108. In some embodiments, the account application 134 reads additional elements from the replacement contactless card 102 along with the unique ID 112. For example, hardware identifiers, such as a MAC address, may be read and sent by the account application 134 to the server 106. Additionally, or alternatively, the account application 134 reads software-based identifiers, such as a digital signature, hash-key, software versions, or other such parameters from the replacement contactless card 102. The account application 134 sends such read values to the server 106 to be associated with the account 140 in case they are to be retrieved in the future.

Further, the method 500 includes activating the replacement contactless card 102 at block 508. For example, the based on the notification, the account application 134 sends an activation notification to the replacement contactless card 102. The activation notification can write a parameter to the replacement contactless card 102 that indicates that the replacement contactless card 102 has been associated with an account, in this case, the account 140. In some embodiments, writing the element can cause the

In some embodiments, for activating the replacement contactless card 102, the server 106 sends one or more parameters associated with the account 140 to the account application 134 to write on to the replacement contactless card 102. For example, the server 106 sends a value of the counter 118 for the account application 134 to write and store onto the replacement contactless card 102. Accordingly, the combination of the new unique ID 112 and the (original) counter 118 can be continued to be used for encryption/decryption described elsewhere herein. In one or more embodiments, once the unique ID 112 and the counter 118 are matched, the replacement contactless card 102 can be deemed to be activated. In other embodiments, other parameters may have to be stored from the account 140 to the replacement contactless card 102, such as the master key 116, the applet 114, etc.

In some embodiments, the replacement contactless card 102 is activated only for a limited duration (e.g., 1 day, 15 days, 1 month, etc.). The limit on the activation may be stored on the replacement contactless card 102. For example, an expiration date and time may be stored on the replacement contactless card 102. The expiration date and time may also be stored by the server 106 in association with the account 140. In other embodiments, the expiration may also be linked with a limited number of uses of the replacement contactless card 102. For example, the counter 118 may be used to limit the number of uses of the replacement contactless card 102 by setting a maximum use threshold. The maximum use threshold may be stored on the replacement contactless card 102 and/or in association with the account 140.

FIG. 6 is a schematic illustrating an embodiment where the server 106 verifies the user 108 using one or more authentication credentials. Based on the verification, the server 106 may create a one-time password (OTP) 202. The OTP 602 can be a pseudo-random code, for example. In some embodiments, the OTP 602 is generated based on one or more attributes of the account 140 associated with the user 108. The server 106 may then transmit the OTP 602 to the account application 134. As shown, the account application 134 may then display the OTP 602 on the display of the computing device 104. The OTP 602 can include a string of characters. The OTP 602 can be read and provided, for example, by typing, pronouncing, etc., by the user 108 to confirm receipt. In some embodiments, the OTP 602 includes or is represented as a matrixed code, which is machine-readable. Doing so allows the OTP 602 to be scanned by a code reader, copied as an image, etc. The OTP 602 is used in some embodiments for multi-factor authentication to verify the user 108. While FIG. 6 depicts an example where the OTP 602 is provided to the computing device 104 from which the user 108 requested verification, in some embodiments, the OTP 602 is provided to the user 108 via a different computing device, distinct from the one from which the user 108 requests verification. In some embodiments, the OTP 602 is provided via a different application, distinct from the account application 134.

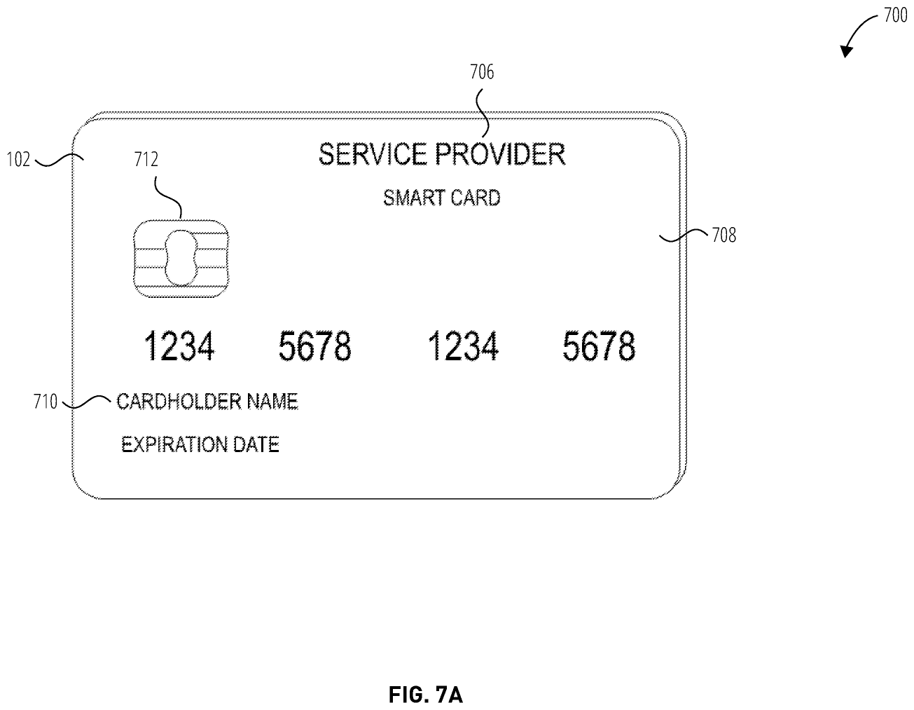

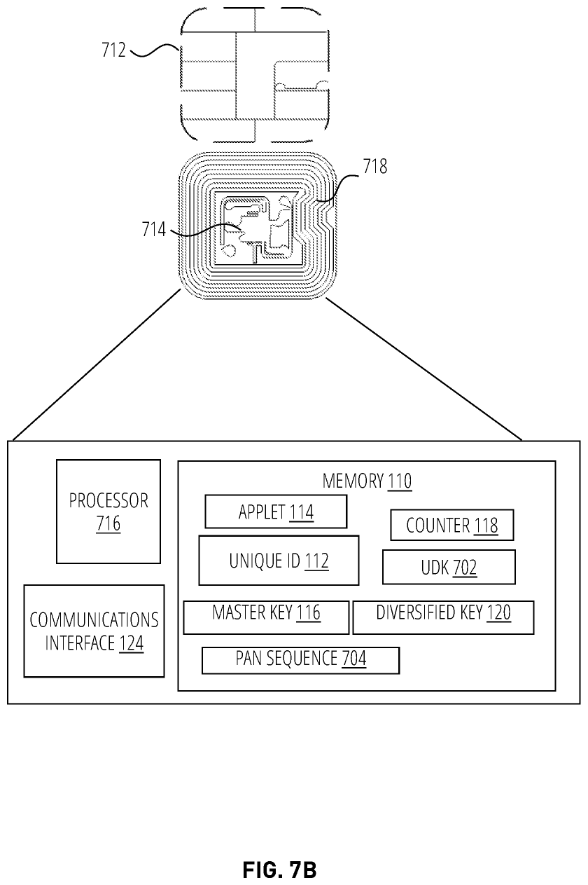

FIG. 7A is a schematic 700 illustrating an example configuration of a contactless card 102, which may include a payment card, such as a credit card, debit card, or gift card, issued by a service provider as displayed as service provider indicia 706 on the front or back of the contactless card 102. In some examples, the contactless card 102 is not related to a payment card, and may include, without limitation, an identification card. In some examples, the transaction card may include a dual interface contactless payment card, a rewards card, and so forth. The contactless card 102 may include a substrate 708, which may include a single layer, or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 102 may have physical characteristics compliant with the ID-1 format of the ISO/IEC 7816 standard, and the transaction card may otherwise be compliant with the ISO/IEC 14443 standard. However, it is understood that the contactless card 102, according to the present disclosure may have different characteristics, and the present disclosure does not require a transaction card to be implemented in a payment card.

The contactless card 102 may also include identification information 710 displayed on the front and/or back of the card, and a contact pad 712. The contact pad 712 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 102 may also include processing circuitry, antenna, and other components as will be further discussed in FIG. 7B. These components may be located behind the contact pad 712 or elsewhere on the substrate 708, e.g., within a different layer of the substrate 708, and may be electrically and physically coupled with the contact pad 712. The contactless card 102 may also include a magnetic strip or tape, which may be located on the back of the card (not shown in FIG. 7A). The contactless card 102 may also include a near field communication (NFC) device coupled with an antenna capable of communicating via the NFC protocol. Embodiments are not limited in this manner.

As illustrated in FIG. 7B, the contact pad 712 of contactless card 102 may include processing circuitry 714 for storing, processing, and communicating information, including a processor 716, a memory 110, and one or more communications interface 124. It is understood that the processing circuitry 714 may contain additional components, including processors, memories, error, and parity/CRC checkers, data encoders, anticollision algorithms, controllers, command decoders, security primitives and tamperproofing hardware, as necessary to perform the functions described herein.

The memory 110 may be a read-only memory, write-once read-multiple memory, or read/write memory, e.g., RAM, ROM, and EEPROM, and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 110 may be encrypted memory utilizing an encryption algorithm executed by the processor 716 to encrypted data.

The memory 110 may be configured to store one or more applet 114, one or more counters 118, a unique ID 112, the master key 116, the UDK 702, diversified key 120, and the PAN sequence 704. The one or more applets 114 may comprise one or more software applications configured to execute on one or more contactless cards 102, such as a Java® Card applet. However, it is understood that applets 114 are not limited to Java Card applets, and instead may be any software application operable on contactless cards or other devices having limited memory. The one or more counters 118 may comprise a numeric counter sufficient to store an integer. The unique ID 112 may comprise a unique alphanumeric identifier assigned to the contactless card 102, and the identifier may distinguish the contactless card 102 from other contactless cards 102. In some examples, the unique ID 112 may identify both a customer and an account assigned to that customer.

The processor 716 and memory elements of the foregoing exemplary embodiments are described with reference to the contact pad 712, but the present disclosure is not limited thereto. It is understood that these elements may be implemented outside of the contact pad 712 or entirely separate from it, or as further elements in addition to processor 716 and memory 110 elements located within the contact pad 712.

In some examples, the contactless card 102 may comprise one or more antenna(s) 718. The one or more antenna(s) 718 may be placed within the contactless card 102 and around the processing circuitry 714 of the contact pad 712. For example, the one or more antenna(s) 718 may be integral with the processing circuitry 714 and the one or more antenna(s) 718 may be used with an external booster coil. As another example, the one or more antenna(s) 718 may be external to the contact pad 712 and the processing circuitry 714.

In an embodiment, the coil of contactless card 102 may act as the secondary of an air core transformer. The terminal may communicate with the contactless card 102 by cutting power or amplitude modulation. The contactless card 102 may infer the data transmitted from the terminal using the gaps in the power connection of the contactless card 102, which may be functionally maintained through one or more capacitors. The contactless card 102 may communicate back by switching a load on the coil of the contactless card 102 or load modulation. Load modulation may be detected in the terminal's coil through interference. More generally, using the antenna(s) 718, processor 716, and/or the memory 110, the contactless card 102 provides a communications interface to communicate via NFC, Bluetooth, and/or Wi-Fi communications.

As explained above, contactless card 102 may be built on a software platform operable on smart cards or other devices having limited memory, such as JavaCard, and one or more or more applications or applets may be securely executed. Applet 114 may be added to contactless cards to provide a one-time password (OTP) for MFA in various mobile application-based use cases. Applet 114 may be configured to respond to one or more requests, such as near field data exchange requests, from a reader, such as a mobile NFC reader (e.g., of a mobile computing device 104 or point-of-sale terminal) and produce an NDEF message that comprises a cryptographically secure OTP encoded as an NDEF text tag. The NDEF message may include a cryptogram such as the cryptogram 122, and any other data.

One example of an NDEF OTP is an NDEF short-record layout (SR=1). In such an example, one or more applet 114 may be configured to encode the OTP as an NDEF type 4 well known type text tag. In some examples, NDEF messages may comprise one or more records. The applet 114 may be configured to add one or more static tag records in addition to the OTP record.

In some examples, the one or more applet 114 may be configured to emulate an RFID tag. The RFID tag may include one or more polymorphic tags. In some examples, each time the tag is read, different cryptographic data is presented that may indicate the authenticity of the contactless card 102. Based on the one or more applet 114, an NFC read of the tag may be processed, the data may be transmitted to a server, such as a server of a banking system, and the data may be validated at the server.

In some examples, the contactless card 102 and server may include certain data such that the card may be properly identified. The contactless card 102 may include one or more unique identifiers (not pictured). Each time a read operation takes place, the counter 118 may be configured to increment. In some examples, each time data from the contactless card 102 is read (e.g., by a mobile device), the counter 118 is transmitted to the server for validation and determines whether the counter 118 are equal (as part of the validation) to a counter of the server.

The one or more counter 118 may be configured to prevent a replay attack. For example, if a cryptogram has been obtained and replayed, that cryptogram is immediately rejected if the counter 118 has been read or used or otherwise passed over. If the counter 118 has not been used, it may be replayed. In some examples, the counter that is incremented on the contactless card 102 is different from the counter that is incremented for transactions. The contactless card 102 is unable to determine the application transaction counter 118 since there is no communication between applets 114 on the contactless card 102. In some examples, the contactless card 102 may comprise a first applet 440-1, which may be a transaction applet, and a second applet 440-2. Each applet 440-1 and 440-2 may comprise a respective counter 118.

In some examples, the counter 118 may get out of sync. In some examples, to account for accidental reads that initiate transactions, such as reading at an angle, the counter 118 may increment but the application does not process the counter 118. In some examples, when the mobile device 10 is woken up, NFC may be enabled and the computing device 104 may be configured to read available tags, but no action is taken responsive to the reads.

To keep the counter 118 in sync, an application, such as a background application, may be executed that would be configured to detect when the computing device 104 wakes up and synchronize with the server of a banking system indicating that a read that occurred due to detection to then move the counter 118 forward. In other examples, Hashed One Time Password may be utilized such that a window of mis-synchronization may be accepted. For example, if within a threshold of 10, the counter 118 may be configured to move forward. But if within a different threshold number, for example within 10 or 600, a request for performing re-synchronization may be processed which requests via one or more applications that the user tap, gesture, or otherwise indicate one or more times via the user's device. If the counter 118 increases in the appropriate sequence, then it possible to know that the user has done so.

The key diversification technique described herein with reference to the counter 118, master key 116, UDK 702, and diversified key 120, is one example of encryption and/or decryption a key diversification technique. This example key diversification technique should not be considered limiting of the disclosure, as the disclosure is equally applicable to other types of key diversification techniques.

During the creation process of the contactless card 102, two cryptographic keys may be assigned uniquely per card. The cryptographic keys may comprise symmetric keys which may be used in both encryption and decryption of data. Triple DES (3DES) algorithm may be used by EMV, and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 102 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

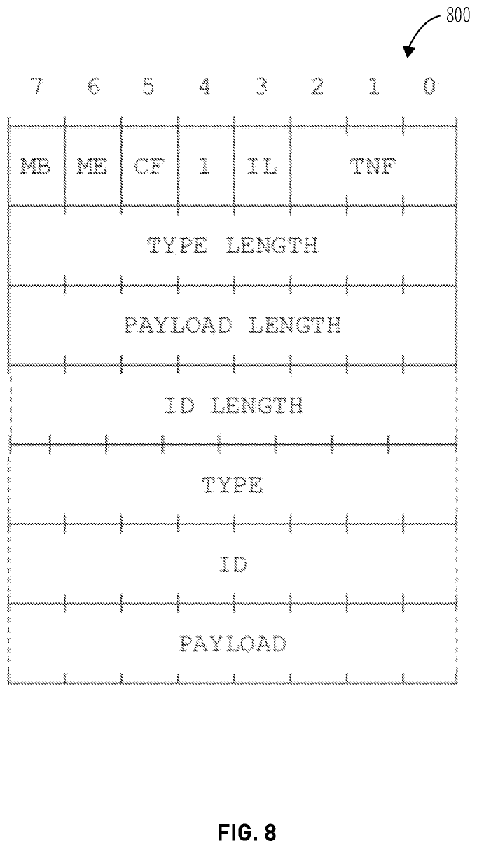

FIG. 8 illustrates an NDEF short-record layout (SR=1) data structure 800 according to an example embodiment. One or more applets 114 may be configured to encode an OTP as an NDEF type 4 well known type text tag. In some examples, NDEF messages may comprise one or more records. The applets may be configured to add one or more static tag records in addition to the OTP record. Exemplary tags include, without limitation, Tag type: well known type, text, encoding English (en); Applet ID: D2760000850101; Capabilities: read-only access; Encoding: the authentication message may be encoded as ASCII hex; type-length-value (TLV) data may be provided as a personalization parameter that may be used to generate the NDEF message. In an embodiment, the authentication template may comprise the first record, with a well-known index for providing the actual dynamic authentication data. The data structure 800 may include a cryptogram such as cryptogram 122 or cryptogram 202, and any other data provided by the applet 114.

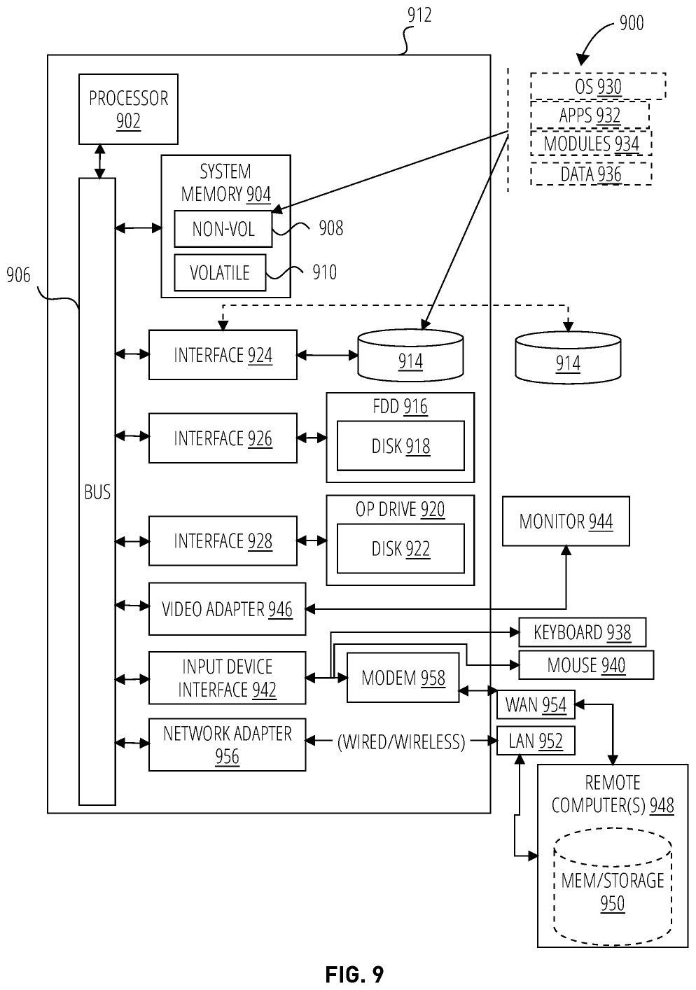

FIG. 9 illustrates an embodiment of an exemplary computer architecture 900 suitable for implementing various embodiments as previously described. In one embodiment, the computer architecture 900 may include or be implemented as part of system 100.

As used in this application, the terms “system” and “component” are intended to refer to a computer-related entity, either hardware, a combination of hardware and software, software, or software in execution, examples of which are provided by the exemplary computing computer architecture 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computer architecture 900 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing computer architecture 900.

As shown in FIG. 9, the computer architecture 900 includes a computer 912 comprising a processor 902, a system memory 904 and a system bus 906. The processor 902 can be any of various commercially available processors. The computer 912 may be representative of the computing device 104 and/or the server 106.

The system bus 906 provides an interface for system components including, but not limited to, the system memory 904 to the processor 902. The system bus 906 can be any of several types of bus structure that may further interconnect to a memory bus (with or without a memory controller), a peripheral bus, and a local bus using any of a variety of commercially available bus architectures. Interface adapters may connect to the system bus 906 via slot architecture. Example slot architectures may include without limitation Accelerated Graphics Port (AGP), Card Bus, (Extended) Industry Standard Architecture ((E) ISA), Micro Channel Architecture (MCA), NuBus, Peripheral Component Interconnect (Extended) (PCI(X)), PCI Express, Personal Computer Memory Card International Association (PCMCIA), and the like.

The computer architecture 900 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 904 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 9, the system memory 904 can include non-volatile 908 and/or volatile 910. A basic input/output system (BIOS) can be stored in the non-volatile 908.

The computer 912 may include various types of computer-readable storage media in the form of one or more lower speed memory units, including an internal (or external) hard disk drive 914, a magnetic disk drive 916 to read from or write to a removable magnetic disk 918, and an optical disk drive 920 to read from or write to a removable optical disk 922 (e.g., a CD-ROM or DVD). The hard disk drive 914, magnetic disk drive 916 and optical disk drive 920 can be connected to the system bus 906 by an HDD interface 924, and FDD interface 926 and an optical disk drive interface 928, respectively. The HDD interface 924 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 908, and volatile 910, including an operating system 930, one or more applications 932, other program modules 934, and program data 936. In one embodiment, the one or more applications 932, other program modules 934, and program data 936 can include, for example, the various applications and/or components of the system 100.

A user can enter commands and information into the computer 912 through one or more wire/wireless input devices, for example, a keyboard 938 and a pointing device, such as a mouse 940. Other input devices may include microphones, infra-red (IR) remote controls, radiofrequency (RF) remote controls, game pads, stylus pens, card readers, dongles, fingerprint readers, gloves, graphics tablets, joysticks, keyboards, retina readers, touch screens (e.g., capacitive, resistive, etc.), trackballs, track pads, sensors, styluses, and the like. These and other input devices are often connected to the processor 902 through an input device interface 942 that is coupled to the system bus 906 but can be connected by other interfaces such as a parallel port, IEEE 1394 serial port, a game port, a USB port, an IR interface, and so forth.

A monitor 944 or other type of display device is also connected to the system bus 906 via an interface, such as a video adapter 946. The monitor 944 may be internal or external to the computer 912. In addition to the monitor 944, a computer typically includes other peripheral output devices, such as speakers, printers, and so forth.

The computer 912 may operate in a networked environment using logical connections via wire and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all the elements described relative to the computer 912, although, for purposes of brevity, only a memory and/or storage device 950 is illustrated. The logical connections depicted include wire/wireless connectivity to a local area network 952 and/or larger networks, for example, a wide area network 954. Such LAN and WAN networking environments are commonplace in offices and companies, and facilitate enterprise-wide computer networks, such as intranets, all of which may connect to a global communications network, for example, the Internet.

When used in a local area network 952 networking environment, the computer 912 is connected to the local area network 952 through a wire and/or wireless communication network interface or network adapter 956. The network adapter 956 can facilitate wire and/or wireless communications to the local area network 952, which may also include a wireless access point disposed thereon for communicating with the wireless functionality of the network adapter 956.

When used in a wide area network 954 networking environment, the computer 912 can include a modem 958, or is connected to a communications server on the wide area network 954 or has other means for establishing communications over the wide area network 954, such as by way of the Internet. The modem 958, which can be internal or external and a wire and/or wireless device, connects to the system bus 906 via the input device interface 942. In a networked environment, program modules depicted relative to the computer 912, or portions thereof, can be stored in the remote memory and/or storage device 950. It will be appreciated that the network connections shown are exemplary and other means of establishing a communications link between the computers can be used.

The computer 912 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, ac, ax, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference to FIGS. 1A-12 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

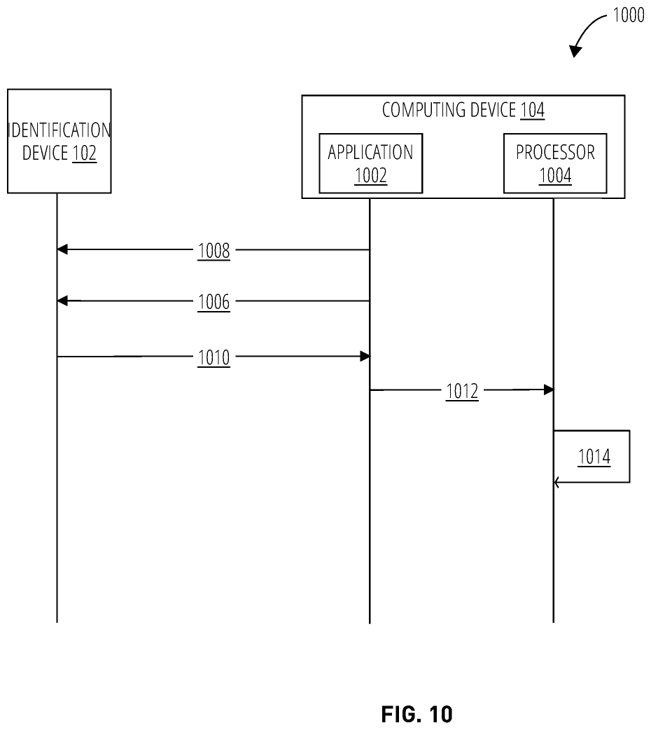

FIG. 10 is a timing diagram illustrating an example sequence for providing authenticated access according to one or more embodiments of the present disclosure. Sequence flow 1000 may include contactless card 102 and computing device 104, which may include an application 1002 and processor 1004. The application 1002 can be any of the applications, such as the account application 134, or any other application that executes on the computing device 104.

At line 1008, the application 1002 communicates with the contactless card 102 (e.g., after being brought near the contactless card 102). Communication between the application 1002 and the contactless card 102 may involve the contactless card 102 being sufficiently close to a card reader (not shown) of the computing device 104 to enable NFC data transfer between the application 1002 and the contactless card 102.

At line 1006, after communication has been established between computing device 104 and contactless card 102, contactless card 102 generates a message authentication code (MAC) cryptogram. In some examples, this may occur when the contactless card 102 is read by the application 1002. In particular, this may occur upon a read, such as an NFC read, of a near field data exchange (NDEF) tag, which may be created in accordance with the NFC Data Exchange Format. For example, a reader application, such as application 1002, may transmit a message, such as an applet select message, with the applet ID of an NDEF producing applet. Upon confirmation of the selection, a sequence of select file messages followed by read file messages may be transmitted. For example, the sequence may include “Select Capabilities file,” “Read Capabilities file,” and “Select NDEF file.” At this point, a counter value maintained by the contactless card 102 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 1002 may be configured to transmit a request to contactless card 102, the request comprising an instruction to generate a MAC cryptogram.

At line 1010, the contactless card 102 sends the MAC cryptogram to the application 1002. In some examples, the transmission of the MAC cryptogram occurs via NFC, however, the present disclosure is not limited thereto. In other examples, this communication may occur via Bluetooth, Wi-Fi, or other means of wireless data communication. At line 1012, the application 1002 communicates the MAC cryptogram to the processor 1004.

At line 1014, the processor 1004 verifies the MAC cryptogram pursuant to an instruction from the application 122. For example, the MAC cryptogram may be verified, as explained below. In some examples, verifying the MAC cryptogram may be performed by a device other than computing device 104, such as a server of a banking system in data communication with the computing device 104. For example, processor 1004 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

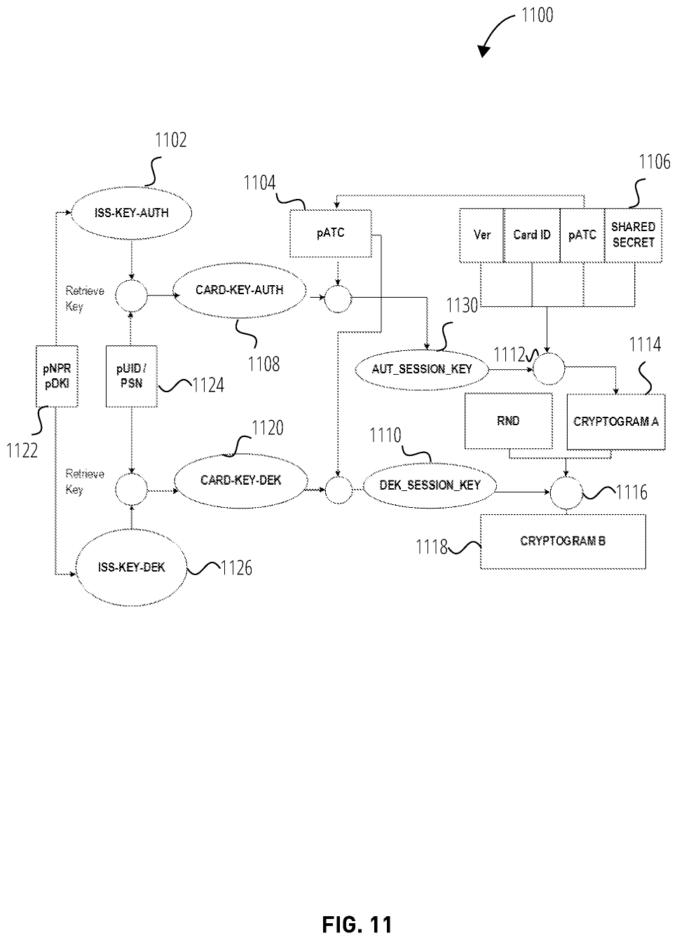

FIG. 11 illustrates a diagram of a system 1100 configured to implement one or more embodiments of the present disclosure. As explained below, during the contactless card creation process, two cryptographic keys may be assigned uniquely for each card. The cryptographic keys may comprise symmetric keys which may be used in both encryption and decryption of data. Triple DES (3DES) algorithm may be used by EMV, and it is implemented by hardware in the contactless card. By using a key diversification process, one or more keys may be derived from a master key based upon uniquely identifiable information for each entity that requires a key.

Regarding master key management, two issuer master keys 1102, 1126 may be required for each part of the portfolio on which the one or more applets is issued. For example, the first master key 1102 may comprise an Issuer Cryptogram Generation/Authentication Key (Iss-Key-Auth) and the second master key 1126 may comprise an Issuer Data Encryption Key (Iss-Key-DEK). As further explained herein, two issuer master keys 1102, 1126 are diversified into card master keys 1108, 1120, which are unique for each card. In some examples, a network profile record ID (pNPR) 522 and derivation key index (pDKI) 1124, as back-office data, may be used to identify which Issuer Master Keys 1102, 1126 to use in the cryptographic processes for authentication. The system performing the authentication may be configured to retrieve values of pNPR 1122 and pDKI 1124 for a contactless card at the time of authentication.

In some examples, to increase the security of the solution, a session key may be derived (such as a unique key per session) but rather than using the master key, the unique card-derived keys and the counter may be used as diversification data, as explained above. For example, each time the card is used in operation, a different key may be used for creating the message authentication code (MAC) and for performing the encryption. Regarding session key generation, the keys used to generate the cryptogram and encipher the data in the one or more applets may comprise session keys based on the card unique keys (Card-Key-Auth 1108 and Card-Key-Dek 1120). The session keys (Aut-Session-Key 1130 and DEK-Session-Key 1110) may be generated by the one or more applets and derived by using the application transaction counter (pATC) 1104 with one or more algorithms. To fit data into the one or more algorithms, only the 2 low order bytes of the 4-byte pATC 1104 is used. In some examples, the four byte session key derivation method may comprise: F1: =PATC (lower 2 bytes)∥‘F0’∥‘00’∥PATC (four bytes) F1:=PATC (lower 2 bytes)∥‘0F’∥‘00’∥PATC (four bytes) SK:={(ALG (MK) [F1])∥ALG (MK) [F2]}, where ALG may include 3DES ECB and MK may include the card unique derived master key.

As described herein, one or more MAC session keys may be derived using the lower two bytes of pATC 1104 counter. At each tap of the contactless card, pATC 1104 is configured to be updated, and the card master keys Card-Key-AUTH 508 and Card-Key-DEK 1120 are further diversified into the session keys Aut-Session-Key 1130 and DEK-Session-KEY 1110. pATC 1104 may be initialized to zero at personalization or applet initialization time. In some examples, the pATC 1104 counter may be initialized at or before personalization and may be configured to increment by one at each NDEF read.

Further, the update for each card may be unique, and assigned either by personalization, or algorithmically assigned by pUID or other identifying information. For example, odd numbered cards may increment or decrement by 2 and even numbered cards may increment or decrement by 5. In some examples, the update may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In some examples, only the authentication data and an 8-byte random number followed by MAC of the authentication data may be included. In some examples, the random number may precede cryptogram A and may be one block long. In other examples, there may be no restriction on the length of the random number. In further examples, the total data (i.e., the random number plus the cryptogram) may be a multiple of the block size. In these examples, an additional 8-byte block may be added to match the block produced by the MAC algorithm. As another example, if the algorithms employed used 16-byte blocks, even multiples of that block size may be used, or the output may be automatically, or manually, padded to a multiple of that block size.

The MAC may be performed by a function key (AUT-Session-Key) 1130. The data specified in cryptogram may be processed with javacard. signature method: ALG_DES MAC8_ISO9797_1_M2_ALG3 to correlate to EMV ARQC verification methods. The key used for this computation may comprise a session key AUT-Session-Key 1130, as explained above. As explained above, the low order two bytes of the counter may be used to diversify for the one or more MAC session keys. As explained below, AUT-Session-Key 1130 may be used to MAC data 1106, and the resulting data or cryptogram An 1114 and random number RND may be encrypted using DEK-Session-Key 1110 to create cryptogram B or output 1118 sent in the message.

In some examples, one or more HSM commands may be processed for decrypting such that the final 16 (binary, 32 hex) bytes may comprise a 3DES symmetric encrypting using CBC mode with a zero IV of the random number followed by MAC authentication data. The key used for this encryption may comprise a session key DEK-Session-Key 1110 derived from the Card-Key-DEK 1120. In this case, the ATC value for the session key derivation is the least significant byte of the counter pATC 1104.

The format below represents a binary version example embodiment. Further, in some examples, the first byte may be set to ASCII ‘A.’

| | | | | |
|---|---|---|---|---|
| Message Format | | | | |
| 1 | 2 | 4 | 8 | 8 |
| 0x43 (Message | Version | pATC | RND | Cryptogram A |
| Type ‘A’) | | | | (MAC) |
| Cryptogram A | 8 bytes | | | |
| (MAC) | | | | |
| MAC of | | | | |
| 2 | 8 | 4 | 4 | 18 bytes input data |
| Version | pUID | pATC | Shared Secret | |
| Message Format | | | | |
| 1 | 2 | 4 | | 16 |
| 0x43 (Message | Version | pATC | | Cryptogram B |
| Type ‘A’) | | | | |
| Cryptogram A | 8 bytes | | | |
| (MAC) | | | | |
| MAC of | | | | |
| 2 | 8 | 4 | 4 | 18 bytes input data |
| Version | pUID | pATC | Shared Secret | |
| Cryptogram B | 16 | | | |
| Sym Encryption | | | | |
| of | | | | |
| 8 | 8 | | | |
| RND | Cryptogram A | | | |

Another exemplary format is shown below. In this example, the tag may be encoded in hexadecimal format.

| | | | | |
|---|---|---|---|---|
| Message Format | | | | |
| 2 | 8 | 4 | 8 | 8 |
| Version | pUID | pATC | RND | Cryptogram A |
| | | | | (MAC) |
| 8 bytes | | | | |
| 8 | 8 | 4 | 4 | 18 bytes input data |
| pUID | pUID | pATC | Shared Secret | |
| Message Format | | | | |
| 2 | 8 | 4 | | 16 |
| Version | pUID | pATC | | Cryptogram B |
| 8 bytes | | | | |
| 8 | | 4 | 4 | 18 bytes input data |
| pUID | pUID | pATC | Shared Secret | |
| Cryptogram B | 16 | | | |
| Sym Encryption | | | | |
| of | | | | |
| 8 | 8 | | | |
| RND | Cryptogram A | | | |

The UID field of the received message may be extracted to derive, from master keys Iss-Key-AUTH 905 and Iss-Key-DEK 910, the card master keys (Card-Key-Auth 925 and Card-Key-DEK 930) for that particular card. Using the card master keys (Card-Key-Auth 508 and Card-Key-DEK 1120), the counter (pATC) field of the received message may be used to derive the session keys (Aut-Session-Key 1130 and DEK-Session-Key 1110) for that particular card. Cryptogram B 1118 may be decrypted using the DEK-Session-KEY, which yields cryptogram An 1114 and RND, and RND may be discarded. The UID field may be used to look up the shared secret of the contactless card which, along with the Ver, UID, and pATC fields of the message, may be processed through the cryptographic MAC using the re-created Aut-Session-Key to create a MAC output, such as MAC.′ If MAC′ is the same as cryptogram An 1114, then this indicates that the message decryption and MAC checking have all passed. Then the pATC may be read to determine if it is valid.

During an authentication session, one or more cryptograms may be generated by the one or more applications. For example, the one or more cryptograms may be generated as a 3DES MAC using ISO 9797-1 Algorithm 3 with Method 2 padding via one or more session keys, such as Aut-Session-Key 1130. The input data 1106 may take the following form: Version (2), pUID (8), pATC (4), Shared Secret (4). In some examples, the numbers in the brackets may comprise length in bytes. In some examples, the shared secret may be generated by one or more random number generators which may be configured to ensure, through one or more secure processes, that the random number is unpredictable. In some examples, the shared secret may comprise a random 4-byte binary number injected into the card at personalization time that is known by the authentication service. During an authentication session, the shared secret may not be provided from the one or more applets to the mobile application. Method 2 padding may include adding a mandatory 0x′80′ byte to the end of input data and 0x′00′ bytes that may be added to the end of the resulting data up to the 8-byte boundary. The resulting cryptogram may comprise 8 bytes in length.

In some examples, one benefit of encrypting an unshared random number as the first block with the MAC cryptogram, is that it acts as an initialization vector while using CBC (Block chaining) mode of the symmetric encryption algorithm. This allows the “scrambling” from block to block without having to pre-establish either a fixed or dynamic IV.

By including the application transaction counter (pATC) as part of the data included in the MAC cryptogram, the authentication service may be configured to determine if the value conveyed in the clear data has been tampered with. Moreover, by including the version in the one or more cryptograms, it is difficult for an attacker to purposefully misrepresent the application version in an attempt to downgrade the strength of the cryptographic solution. In some examples, the pATC may start at zero and be updated by 1 each time the one or more applications generates authentication data. The authentication service may be configured to track the pATCs used during authentication sessions. In some examples, when the authentication data uses a pATC equal to or lower than the previous value received by the authentication service, this may be interpreted as an attempt to replay an old message, and the authenticated may be rejected. In some examples, where the pATC is greater than the previous value received, this may be evaluated to determine if it is within an acceptable range or threshold, and if it exceeds or is outside the range or threshold, verification may be deemed to have failed or be unreliable. In the MAC operation 1112, data 1106 is processed through the MAC using Aut-Session-Key 1130 to produce MAC output (cryptogram A) 1114, which is encrypted.

In order to provide additional protection against brute force attacks exposing the keys on the card, it is desirable that the MAC cryptogram 1114 be enciphered. In some examples, data or cryptogram An 1114 to be included in the ciphertext may comprise: Random number (8), cryptogram (8). In some examples, the numbers in the brackets may comprise length in bytes. In some examples, the random number may be generated by one or more random number generators which may be configured to ensure, through one or more secure processes, that the random number is unpredictable. The key used to encipher this data may comprise a session key. For example, the session key may comprise DEK-Session-Key 1110. In the encryption operation 1116, data or cryptogram An 1114 and RND are processed using DEK-Session-Key 510 to produce encrypted data, cryptogram B 1118. The data 1114 may be enciphered using 3DES in cipher block chaining mode to ensure that an attacker must run any attacks over all of the ciphertext. As a non-limiting example, other algorithms, such as Advanced Encryption Standard (AES), may be used. In some examples, an initialization vector of 0x′0000000000000000′ may be used. Any attacker seeking to brute force the key used for enciphering this data will be unable to determine when the correct key has been used, as correctly decrypted data will be indistinguishable from incorrectly decrypted data due to its random appearance.

In order for the authentication service to validate the one or more cryptograms provided by the one or more applets, the following data must be conveyed from the one or more applets to the mobile device in the clear during an authentication session: version number to determine the cryptographic approach used and message format for validation of the cryptogram, which enables the approach to change in the future; pUID to retrieve cryptographic assets, and derive the card keys; and pATC to derive the session key used for the cryptogram.

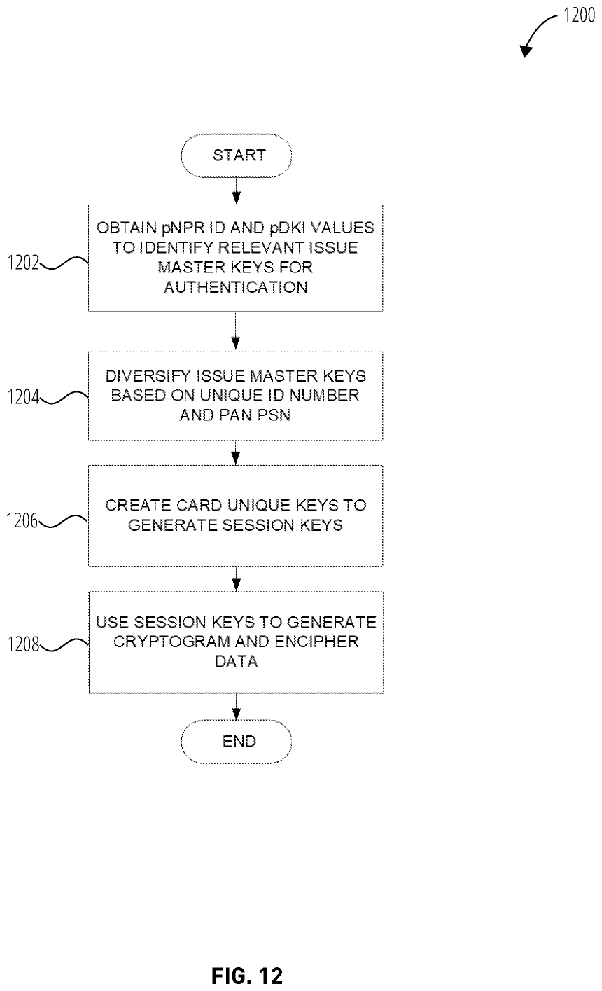

FIG. 12 illustrates a method 1200 for generating a cryptogram. For example, at block 1202, a network profile record ID (pNPR) and derivation key index (pDKI) may be used to identify which Issuer Master Keys to use in the cryptographic processes for authentication. In some examples, the method may include performing the authentication to retrieve values of pNPR and pDKI for a contactless card at the time of authentication.

At block 1204, Issuer Master Keys may be diversified by combining them with the card's unique ID number (pUID) and the PAN sequence number (PSN) of one or more applets, for example, a payment applet.

At block 1206, Card-Key-Auth and Card-Key-DEK (unique card keys) may be created by diversifying the Issuer Master Keys to generate session keys which may be used to generate a MAC cryptogram.

At block 1208, the keys used to generate the cryptogram and encipher the data in the one or more applets may comprise the session keys of block 1030 based on the card unique keys (Card-Key-Auth and Card-Key-DEK). In some examples, these session keys may be generated by the one or more applets and derived by using pATC, resulting in session keys Aut-Session-Key and DEK-Session-Key.

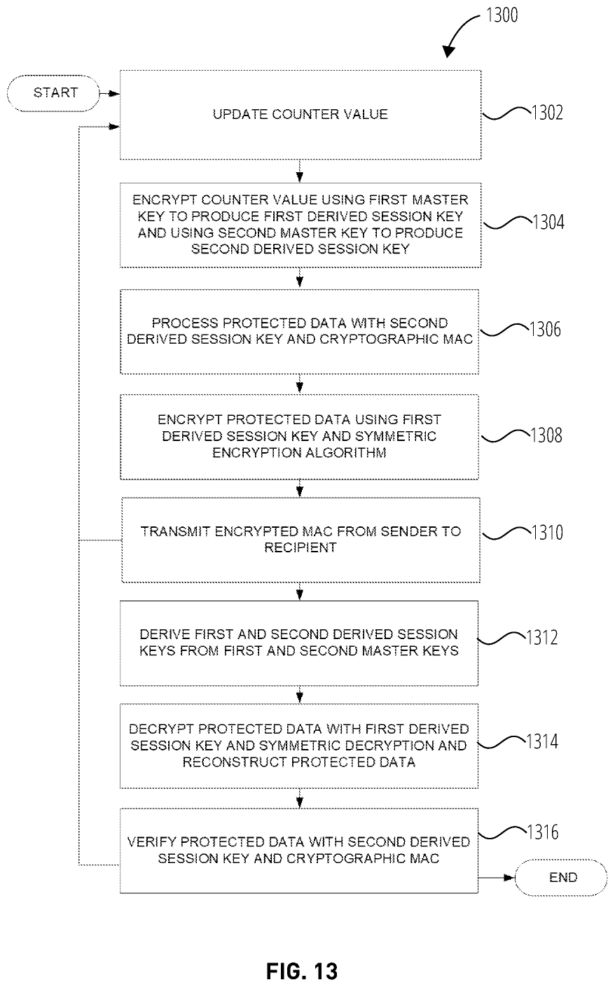

FIG. 13 depicts an exemplary process 1300 illustrating key diversification according to one example. Initially, a sender and the recipient may be provisioned with two different master keys. For example, a first master key may comprise the data encryption master key, and a second master key may comprise the data integrity master key. The sender has a counter value, which may be updated at block 1302, and other data, such as data to be protected, which it may secure share with the recipient.

At block 1304, the counter value may be encrypted by the sender using the data encryption master key to produce the data encryption derived session key, and the counter value may also be encrypted by the sender using the data integrity master key to produce the data integrity derived session key. In some examples, a whole counter value or a portion of the counter value may be used during both encryptions.

In some examples, the counter value may not be encrypted. In these examples, the counter may be transmitted between the sender and the recipient in the clear, i.e., without encryption.

At block 1306, the data to be protected is processed with a cryptographic MAC operation by the sender using the data integrity session key and a cryptographic MAC algorithm. The protected data, including plaintext and shared secret, may be used to produce a MAC using one of the session keys (AUT-Session-Key).

At block 1308, the data to be protected may be encrypted by the sender using the data encryption derived session key in conjunction with a symmetric encryption algorithm. In some examples, the MAC is combined with an equal amount of random data, for example each 8 bytes long, and then encrypted using the second session key (DEK-Session-Key).

At block 1310, the encrypted MAC is transmitted, from the sender to the recipient, with sufficient information to identify additional secret information (such as shared secret, master keys, etc.), for verification of the cryptogram.

At block 1312, the recipient uses the received counter value to independently derive the two derived session keys from the two master keys as explained above.

At block 1314, the data encryption derived session key is used in conjunction with the symmetric decryption operation to decrypt the protected data. Additional processing on the exchanged data will then occur. In some examples, after the MAC is extracted, it is desirable to reproduce and match the MAC. For example, when verifying the cryptogram, it may be decrypted using appropriately generated session keys. The protected data may be reconstructed for verification. A MAC operation may be performed using an appropriately generated session key to determine if it matches the decrypted MAC. As the MAC operation is an irreversible process, the only way to verify is to attempt to recreate it from source data.

At block 1316, the data integrity derived session key is used in conjunction with the cryptographic MAC operation to verify that the protected data has not been modified.

Some examples of the methods described herein may advantageously confirm when a successful authentication is determined when the following conditions are met. First, the ability to verify the MAC shows that the derived session key was proper. The MAC may only be correct if the decryption was successful and yielded the proper MAC value. The successful decryption may show that the correctly derived encryption key was used to decrypt the encrypted MAC. Since the derived session keys are created using the master keys known only to the sender (e.g., the transmitting device) and recipient (e.g., the receiving device), it may be trusted that the contactless card which originally created the MAC and encrypted the MAC is indeed authentic. Moreover, the counter value used to derive the first and second session keys may be shown to be valid and may be used to perform authentication operations.

Thereafter, the two derived session keys may be discarded, and the next iteration of data exchange will update the counter value (returning to block 1302) and a new set of session keys may be created (at block 1310). In some examples, the combined random data may be discarded.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed is:

1. A computer-implemented method to program a contactless card, the computer-implemented method comprising:
receiving, by a server, a first request to associate the contactless card with an account, the first request received via an authenticated computing application;
authenticating, by the server, that the first request was received from an account holder of the account; and
based on establishing authenticity of the account holder, determining, by the server, a unique identifier of the account holder associated with the account, and sending, by the server, a second request to the authenticated computing application to write the unique identifier of the account holder to the contactless card.

2. The computer-implemented method of claim 1, wherein authenticating the account holder comprises a multi-factor authentication.

3. The computer-implemented method of claim 2, wherein the multi-factor authentication comprises sending a verification code via an email, a text message, a phone call, an instant message, and an authentication application.

4. The computer-implemented method of claim 1, wherein the authenticated computing application is one from a group comprising a mobile application, a web-based application, a voice-based application, and a chat-based application.

5. The computer-implemented method of claim 1, wherein the unique identifier is associated with a second contactless card of the account holder.

6. The computer-implemented method of claim 1, further comprising, verifying that the contactless card meets at least a threshold compatibility.

7. The computer-implemented method of claim 1, wherein the unique identifier is written to the contactless card using a near field communication protocol.

8. The computer-implemented method of claim 1, wherein the unique identifier is written to a specific portion of memory of the contactless card.

9. The computer-implemented method of claim 1, wherein the unique identifier that is provided to be written to the contactless card is newly created for the account holder, replacing an older unique identifier of the account holder.

10. A computing device comprising:
a processor; and
a memory storing instructions that, when executed by the processor, configure the computing device to:
receive a first request to associate a contactless card with an account, the first request received from a second computing device;
authenticate that the first request was received from an account holder of the account; and
based on establishing authenticity of the account holder, send a second request to the second computing device to write a unique identifier of the account holder to the contactless card.

11. The computing device of claim 10, wherein authenticating the account holder comprises a multi-factor authentication.

12. The computing device of claim 11, wherein the multi-factor authentication comprises sending a verification code via an email, a text message, a phone call, an instant message, and an authentication application.

13. The computing device of claim 10, wherein the unique identifier is associated with a second contactless card of the account holder.

14. The computing device of claim 10, wherein the memory further comprises instructions that configure the computing device to verify that the contactless card meets at least a threshold compatibility.

15. The computing device of claim 10, wherein the unique identifier is written to the contactless card using a near field communication protocol.

16. The computing device of claim 10, wherein the unique identifier that is provided to be written to the contactless card is newly created for the account holder, replacing an older unique identifier of the account holder.

17. A non-transitory computer-readable storage medium, the computer-readable storage medium including instructions that when executed by a computing device, cause the computing device to:
receive a first request to associate a contactless card with an account, the first request received from a second computing device;
authenticate that the first request was received from an account holder of the account; and
based on establishing authenticity of the account holder, send a second request to the second computing device to write a unique identifier of the account holder to the contactless card.

18. The non-transitory computer-readable storage medium of claim 17, wherein the multi-factor authentication comprises sending a verification code via an email, a text message, a phone call, an instant message, and an authentication application.

19. The non-transitory computer-readable storage medium of claim 17, wherein the computing device is further configured to verify that the contactless card meets at least a threshold compatibility.

20. The non-transitory computer-readable storage medium of claim 17, wherein the unique identifier that is provided to be written to the contactless card is newly created for the account holder, replacing an older unique identifier of the account holder.
